(19) United States
(12) Patent Application Publication
(10) Pub. No.: US 2024/0372569 A1
(43) Pub. Date: Nov. 7, 2024

(54) MIMO RADIO FREQUENCY FRONT END SYSTEMS AND METHODS

(71) Applicant: Skyworks Solutions, Inc., Irvine, CA (US)

(72) Inventor: David Richard Pehlke, Westlake Village, CA (US)

(21) Appl. No.: 18/653,934

(22) Filed: May 2, 2024

Related U.S. Application Data
(60) Provisional application No. 63/463,743, filed on May 3, 2023.

(51) Int. Cl. H04B 1/00; H04B 7/024; H04B 7/0413

(52) U.S. Cl. CPC H04B 1/0064; H04B 7/024; H04B 7/0413

(57) ABSTRACT

A radio frequency front end includes a first receiver system including a first receive path connected to a first antenna and configured to output a first receive signal in a first band, a second receive path connected to a second antenna and configured to split a first filtered receive signal to output a second receive signal in the first band and to output a third receive signal in a second band, the second band adjacent to the first band, and a third receive path connected to a third antenna and configured to output a fourth receive signal in the second band. The system can includes a second similar receiver system connected to three additional antennas, and be configured for 4×4 downlink MIMO operation.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to electronic systems, and in particular, to radio frequency (RF) electronics supporting concurrent reception and transmission over a plurality of bands.

### Description of the Related Technology

RF communication systems can be used for transmitting and/or receiving signals of a wide range of frequencies. For example, a RF communication system can be used to wirelessly communicate RF signals in a frequency range of about 30 kHz to 300 GHz, such as in the range of about 450 MHz to about 7.125 GHz for certain communications standards, e.g., Fifth Generation (5G) cellular communications.

Supported technologies and standards can include Long-Term Evolution (LTE), Evolved-Universal Terrestrial Radio Access (E-UTRA) New Radio (NR) dual connectivity (EN-DC), carrier aggregation (CA), and/or multi-input and multi-output (MIMO) in 5G & millimeter wave technology.

Examples of RF communication devices include, but are not limited to, mobile phones, tablets, base stations, network access points, customer-premises equipment (CPE), laptops, and wearable electronics.

### SUMMARY OF CERTAIN INVENTIVE CONCEPTS

The systems, methods and devices of this disclosure each have several aspects, no single one of which is solely responsible for the desirable attributes disclosed herein.

In certain applications, RF communications systems/mobile wireless devices can be simultaneously and/or multiply connected to one or more networks of the same and/or of different generations and at same, similar, or different bands and transmit and/or receive a plurality of RF signals simultaneously. RF front-ends (RFFEs) are used for RF signal reception (Rx) and transmission (Tx). Where Rx and Tx are concurrently on, high levels of isolation can be helpful, for instance to reduce intermodulation distortion (IMD).

Furthermore, dependent on what frequency band is used for wireless communications, the mobile devices use an antenna system can include several sets of antenna units for different bands. One or more of the antenna units can be used for the respective frequency band in order to conduct 4×4 DL MIMO exhibiting in particular highly efficient downlink reception at high data rates.

While higher orders of MIMO such as 4×4 DL MIMO have been achieved in certain frequency bands, e. g. in the n77 or n79 frequency band, in some bands higher orders of MIMO such as 4×4 DL MIMO are more challenging, and typically lower orders of MIMO, such as 2×2 DL MIMO are available. For example, higher order MIMO can be challenging for LTE B46, which is in the frequency range of 5.150-5.925 GHZ and is typically used for 5 GHz WiFi. One reason for this is that, for some devices, for the 5G n77 or n79 frequency bands, the antenna system comprises a sufficient number of antennas to enable 4 reception paths in n77 or n79. However, some devices include only two antennas for B46. According to certain disclosed systems and methods, 4×4 downlink MIMO for B46 is achieved, e.g., without adding further antenna units.

In today's modern mobile devices/smartphones, the band explosion and fragmentation of radio access technologies has grown the complexity and fixed band-specific RF path content in the radio front-end (RFFE). Many of the paths are designed to operate concurrently and multiple antenna technologies are a central part of doubling and quadrupling data rates in modern cellular communication systems using MIMO, where overlapping data streams transmitted from different antennas can be received and separated from each other because of orthogonality in the antenna behavior and radio channel propagation characteristics.

LTE bands typically support at least 2×2 DL-MIMO from release 8 at the beginning of the 3GPP definition of LTE. In addition, several 5G/NR (new radio) bands support 4×4 DL-MIMO (n7, n38, n41, n77, n78, n79), which provides performance benefits by supporting simultaneous higher order DL-MIMO. Some MB, HB, UHB bands in the frequency range 1.7 GHZ-3.6 GHz can support 4×4 DL-MIMO in LTE higher end phones.

However, supporting 4×4 DL MIMO for B46 presents certain challenges. B46 is in the unlicensed 5 GHz WiFi ISM band, and operates as “licensed assisted access” (“LAA”), e.g., opportunistically implementing “listen before talk” protocols to jump on available channels and using “fair shared use” of the channels with other wireless services in the band that are not coordinated by a single central radio access technology (RAT) base station as in the other bands which operate as licensed cellular networks.

In B46, the cellular network can share use with other non-coordinated radio access technologies (RATs), and mobile device RFFEs can re-use the existing 5 GHz WiFi RF modules and transmit/receive paths for B46 because 5 Ghz WiFi is a common band and frequency range. However, 5 GHz WiFi is typically limited to 2×2 DL-MIMO because of cost and chipset platform support.

Hence, certain embodiments disclosed herein enable 4×4 downlink MIMO for the B46 frequency band, e.g., without adding further antenna units in the mobile devices for this frequency range.

For instance, a radio frequency (RF) front end (RFFE) system can include a receiver system for receiving radio frequency (RF) signals from an antenna system, the receiver system comprising a first receiver unit configured to receive a first RF signal from a first antenna unit of the antenna system, the first receiver unit including a first receive (Rx) path, and the first Rx path of the first receiver unit being adapted to process the first RF signal and output a first reception signal in a first frequency band and a second reception signal in a second frequency band, the first and second frequency bands being adjacent to each other. The first frequency band may be the B46 frequency band and the second frequency band may be the adjacent n79 frequency band. According to an embodiment, the received first RF signal may be bandpass filtered with a bandpass filter corresponding to the first and second frequency band, may be then amplified by a first amplifier, and then split by a splitter into the first and second reception signals. Providing this configuration two times, two existing n79 receive paths can be re-used to add two B46 receive paths such that the existing two B46 receive paths can be extended to four receive paths, hence realizing full 4×4 DL-MIMO for the B46 band.

In some aspects, the techniques described herein relate to a radio frequency front end system including: a first receiver system including a first receive path connected to a first antenna and configured to output a first receive signal in a first band, a second receive path connected to a second antenna and configured to split a first filtered receive signal to output a second receive signal in the first band and to output a third receive signal in a second band, the second band adjacent to the first band, and a third receive path connected to a third antenna and configured to output a fourth receive signal in the second band; and a second receiver system including a fourth receive path connected to a fourth antenna and configured to output a fifth receive signal in the first band, a fifth receive path connected to a fifth antenna and configured to split a second filtered receive signal to output a sixth receive signal in the first band and to output a seventh receive signal in the second band, and a sixth receive path connected to a sixth antenna and configured to output an eighth receive signal in the second band.

In some aspects, the techniques described herein relate to a radio frequency front end system wherein the radio frequency front end system is adapted to output the first, second, fifth, and sixth receive signals simultaneously for 4×4 DL-MIMO operation in the first band.

In some aspects, the techniques described herein relate to a radio frequency front end system wherein the radio frequency front end system is adapted to output the third, fourth, seventh, and eighth receive signals simultaneously for 4×4 DL-MIMO operation in the second band.

In some aspects, the techniques described herein relate to a radio frequency front end system wherein the first band is 4G LTE B46 and the second band is 5G NR n79.

In some aspects, the techniques described herein relate to a radio frequency front end system the third receive path is configured to split a third filtered receive signal to output the fourth receive signal in the second band and to output a ninth receive signal in a third band, and the sixth receive path is configured to split a fourth filtered receive signal to output the eighth receive signal in the second band and to output a tenth receive signal in the third band.

In some aspects, the techniques described herein relate to a radio frequency front end system wherein the first band is 4G LTE B46, the second band is 5G NR n79, and the third band is 5 GHz WiFi.

In some aspects, the techniques described herein relate to a radio frequency front end system wherein the first receiver system is positioned in a first location in a mobile device, and the second receiver system is positioned in a second location in the mobile device spaced from the first location.

In some aspects, the techniques described herein relate to a radio frequency front end system wherein the first location is within a near side of the mobile device, and the second location is within a far side of the mobile device.

In some aspects, the techniques described herein relate to a radio frequency front end system wherein the second receive path includes a first bandpass filter adapted to filter the first filtered receive signal with a passband having a frequency range including the first band and the second band, and the fifth receive path includes a second bandpass filter adapted to filter the second filtered receive signal with a passband having a frequency range including the first band and the second bands.

In some aspects, the techniques described herein relate to a radio frequency front end system wherein the second receive path includes a first power splitter configured to split the first filtered receive signal into the second receive signal and third receive signal, and the fifth receive path includes a second power splitter configured to split the second filtered receive signal into the sixth receive signal and the seventh receive signal.

In some aspects, the techniques described herein relate to a radio frequency front end system wherein the second receive path further includes a first amplifier amplifying the second receive signal in a first frequency range including the first band, and a second amplifier amplifying the third receive signal in a second frequency range including the second band, and the fifth receive path further includes a third amplifier amplifying the sixth receive signal in the first frequency range, and a fourth amplifier amplifying the seventh receive signal in the second frequency range.

In some aspects, the techniques described herein relate to a mobile device including: first, second, third, fourth, fifth, and sixth antennas; and a radio frequency front end system including a first receive path connected to a first antenna and configured to output a first receive signal in a first band, a second receive path connected to a second antenna and configured to split a first filtered receive signal to output a second receive signal in the first band and to output a third receive signal in a second band, the second band adjacent to the first band, a third receive path connected to a third antenna and configured to output a fourth receive signal in the second band, a fourth receive path connected to a fourth antenna and configured to output a fifth receive signal in the first band, a fifth receive path connected to a fifth antenna and configured to split a second filtered receive signal to output a sixth receive signal in the first band and to output a seventh receive signal in the second band, and a sixth receive path connected to a sixth antenna and configured to output an eighth receive signal in the second band.

In some aspects, the techniques described herein relate to a mobile device wherein the radio frequency front end system is adapted to output the first, second, fifth, and sixth receive signals simultaneously for 4×4 DL-MIMO operation in the first band.

In some aspects, the techniques described herein relate to a mobile device wherein the radio frequency front end system is adapted to output the third, fourth, seventh, and eighth receive signals simultaneously for 4×4 DL-MIMO operation in the second band.

In some aspects, the techniques described herein relate to a mobile device wherein the first band is 4G LTE B46 and the second band is 5G NR n79.

In some aspects, the techniques described herein relate to a mobile device the third receive path is configured to split a third filtered receive signal to output the fourth receive signal in the second band and to output a ninth receive signal in a third band, and the sixth receive path is configured to split a fourth filtered receive signal to output the eighth receive signal in the second band and to output a tenth receive signal in the third band.

In some aspects, the techniques described herein relate to a mobile device wherein the first band is 4G LTE B46, the second band is 5G NR n79, and the third band is 5 GHz WiFi.

In some aspects, the techniques described herein relate to a mobile device wherein the first, second, and third receive paths are positioned in a first location in a mobile device, and the fourth, fifth, and sixth receive paths are positioned in a second location in the mobile device spaced from the first location.

In some aspects, the techniques described herein relate to a mobile device wherein the first location is within a near side of the mobile device, and the second location is within a far side of the mobile device.

In some aspects, the techniques described herein relate to a mobile device wherein the second receive path includes a first bandpass filter adapted to filter the first filtered receive signal with a passband having a frequency range including the first band and the second band, and the fifth receive path includes a second bandpass filter adapted to filter the second filtered receive signal with a passband having a frequency range including the first band and the second bands.

In some aspects, the techniques described herein relate to a radio frequency front end system including: a receiver system for receiving radio frequency signals from an antenna system, the receiver system including: a first receiver unit configured to receive a first radio frequency signal from a first antenna unit of the antenna system; the first receiver unit including a first receive path; and the first receive path of the first receiver unit being adapted to process the first radio frequency signal and output a first reception signal in a first frequency band and a second reception signal in a second frequency band, the first and second frequency bands being adjacent to each other.

In some aspects, the techniques described herein relate to a radio frequency front end system, the receiver system further including a second receiver unit configured to receive a second radio frequency signal from a second antenna unit of the antenna system, the second receiver unit including a first receive path adapted to process the second radio frequency signal and output a third reception signal in the first frequency band and a fourth reception signal in the second frequency band.

In some aspects, the techniques described herein relate to a radio frequency front end system, the receiver system further including a third receiver unit configured to receive a third radio frequency signal from a third antenna unit of the antenna system, the third receiver unit including a first receive path adapted to process the third radio frequency signal and output a fifth reception signal in the first frequency band and a sixth reception signal in a third frequency band.

In some aspects, the techniques described herein relate to a radio frequency front end system, the receiver system further including a fourth receiver unit configured to receive a fourth radio frequency signal from a fourth antenna unit of the antenna system, the fourth receiver unit including a first receive path adapted to process the fourth radio frequency signal and output a seventh reception signal in the first frequency band and an eighth reception signal in the third frequency band.

In some aspects, the techniques described herein relate to a radio frequency front end system wherein the first receiver unit includes a second receive path configured to receive a fifth radio frequency signal from the first antenna unit, the second receive path of the first receiver unit being adapted to process the fifth radio frequency signal and output a ninth reception signal in a fourth frequency band.

In some aspects, the techniques described herein relate to a radio frequency front end system wherein the second receiver unit includes a second receive path configured to receive a sixth radio frequency signal from the second antenna unit, the second receive path of the second receiver unit being adapted to process the sixth radio frequency signal and output a tenth reception signal in the fourth frequency band.

In some aspects, the techniques described herein relate to a radio frequency front end system wherein the third receiver unit includes a second receive path configured to receive a seventh radio frequency signal from the third antenna unit, the second receive path of the third receiver unit being adapted to process the seventh radio frequency signal and output an eleventh reception signal in a fifth frequency band.

In some aspects, the techniques described herein relate to a radio frequency front end system wherein the fourth receiver unit includes a second receive path configured to receive an eighth radio frequency signal from the fourth antenna unit, the second receive path of the fourth receiver unit being adapted to process the tenth radio frequency signal and output a twelfth reception signal in the fifth frequency band.

In some aspects, the techniques described herein relate to a radio frequency front end system wherein the receiver system is adapted to output the first, third, fifth and seventh reception signals in the first frequency band simultaneously for 4×4 DL-MIMO reception.

In some aspects, the techniques described herein relate to a radio frequency front end system wherein the first frequency band is the B46 band, the second frequency band is the n79 band, the third frequency band is the 5 GHz WiFi band, the fourth frequency band is the n77 band, and the fifth frequency band is the 2.4 GHz WiFi band.

In some aspects, the techniques described herein relate to a radio frequency front end system wherein the first and the third receiver units are located on the near side of a user equipment and the second and third receiver units are located on a far side of the user equipment.

In some aspects, the techniques described herein relate to a radio frequency front end system wherein the first receive path of the first receiver unit includes a bandpass filter adapted to filter the first radio frequency signal with a passband including the first and second frequency bands.

In some aspects, the techniques described herein relate to a radio frequency front end system wherein the first receive path of the second receiver unit includes a bandpass filter adapted to filter the second radio frequency signal with a passband including the first and second frequency bands.

In some aspects, the techniques described herein relate to a radio frequency front end system wherein the first receive path of the first receiver unit further includes a first amplifier configured to amplify the filtered first radio frequency signal in a frequency range including the first and second frequency band.

In some aspects, the techniques described herein relate to a radio frequency front end system wherein the first receive path of the second receiver unit further includes a first amplifier configured to amplify the filtered second radio frequency signal in a frequency range including the first and second frequency band.

In some aspects, the techniques described herein relate to a radio frequency front end system wherein the first receive path of the first receiver unit further includes a first splitter adapted to split the filtered and amplified first radio frequency signal into the first and second reception signals.

In some aspects, the techniques described herein relate to a radio frequency front end system wherein the first receive path of the second receiver unit further includes a second splitter adapted to split the filtered and amplified second radio frequency signal into the third and fourth reception signals.

In some aspects, the techniques described herein relate to a radio frequency front end system wherein the first receive path of the first receiver unit further includes a second amplifier and a third amplifier, the second amplifier amplifying the first reception signal in the first frequency range, and the third amplifier amplifying the second reception signal in the second frequency range.

In some aspects, the techniques described herein relate to a radio frequency front end system wherein the first receive path of the second receiver unit further includes a second amplifier and a third amplifier, the second amplifier amplifying the third reception signal in the first frequency range, and the third amplifier amplifying the fourth reception signal in the second frequency range.

In some aspects, the techniques described herein relate to a radio frequency front end system wherein the second receive path of the first reception unit includes a bandpass filter configured to filter the fifth radio frequency signal with a passband including the fourth frequency band and an amplifier adapted to amplify the filtered fifth radio frequency signal and output the amplified filtered fifth radio frequency signal as the ninth reception signal.

In some aspects, the techniques described herein relate to a radio frequency front end system wherein the second receive path of the second reception unit includes a bandpass filter configured to filter the sixth radio frequency signal with a passband including the fourth frequency band and an amplifier adapted to amplify the filtered sixth radio frequency signal and output the amplified filtered sixth radio frequency signal as the tenth reception signal.

In some aspects, the techniques described herein relate to a radio frequency front end system wherein the first receive path of the third reception unit includes an amplifier configured to amplify the third radio frequency signal, a splitter adapted to split the amplified third radio frequency signal into the fifth and sixth reception signals, and two amplifiers configured to respectively amplify the fifth and sixth reception signal.

In some aspects, the techniques described herein relate to a radio frequency front end system wherein the first receive path of the fourth reception unit includes an amplifier configured to amplify the fourth radio frequency signal, a splitter adapted to split the amplified fourth radio frequency signal into the seventh and eighth reception signals, and two amplifiers configured to respectively amplify the seventh and eighth reception signal.

In some aspects, the techniques described herein relate to a radio frequency front end system, wherein the receiver system is adapted to output the first, third, fifth and seventh reception signals simultaneously for B46 4×4 DL-MIMO reception.

In some aspects, the techniques described herein relate to a device including: an antenna system including a first to fourth antenna unit; and a radio frequency front end system including a receiver system for receiving radio frequency signals from the antenna system, the radio frequency front end being coupled to the antenna system; and the receiver system including: a first receiver unit configured to receive a first radio frequency signal from the first antenna unit of the antenna system; the first receiver unit including a first receive path; and the first receive path of the first receiver unit being adapted to process the first radio frequency signal and output a first reception signal in a first frequency band and a second reception signal in a second frequency band, the first and second frequency bands being adjacent to each other.

In some aspects, the techniques described herein relate to a device, the receiver system further including a second receiver unit configured to receive a second radio frequency signal from the second antenna unit of the antenna system, the second receiver unit including a first receive path adapted to process the second radio frequency signal and output a third reception signal in the first frequency band and a fourth reception signal in the second frequency band.

In some aspects, the techniques described herein relate to a device, the receiver system further including a third receiver unit configured to receive a third radio frequency signal from the third antenna unit of the antenna system, the third receiver unit including a first receive path adapted to process the third radio frequency signal and output a fifth reception signal in the first frequency band and a sixth reception signal in a third frequency band.

In some aspects, the techniques described herein relate to a device, the receiver system further including a fourth receiver unit configured to receive a fourth radio frequency signal from the fourth antenna unit of the antenna system, the fourth receiver unit including a first receive path adapted to process the fourth radio frequency signal and output a seventh reception signal in the first frequency band and an eighth reception signal in the third frequency band.

In some aspects, the techniques described herein relate to a device wherein the first frequency band is the B46 band, the second frequency band is the n79 band, the third frequency band is the 5 GHz WiFi band, the fourth frequency band is the n77 band, and the fifth frequency band is the 2.4 GHz WiFi band.

In some aspects, the techniques described herein relate to a device, wherein the receiver system is adapted to output the first, third, fifth and seventh reception signals simultaneously for B46 4×4 DL-MIMO reception.

In some aspects, the techniques described herein relate to a method of performing wireless communication using a radio frequency front end system including a receiver system for receiving radio frequency signals from an antenna system, the receiver system including a first receiver unit including a first receive path, the method including: receiving, by the first receiver unit, a first radio frequency signal from a first antenna unit of the antenna system; and processing, by the first receive path of the first receiver unit, the first radio frequency signal and outputting a first reception signal in a first frequency band and a second reception signal in a second frequency band, the first and second frequency bands being adjacent to each other.

In some aspects, the techniques described herein relate to a method wherein the antenna system further includes a second antenna unit, the receiver system further includes a second receiver unit including a first receive path, and the method further includes: receiving, by the second receiver unit, a second radio frequency signal from the second antenna unit; and processing, by the first receive path of the second receiver unit, the second radio frequency signal and outputting a third reception signal in the first frequency band and a fourth reception signal in the second frequency band.

In some aspects, the techniques described herein relate to a method wherein the antenna system further includes a third antenna unit, the receiver system further includes a third receiver unit including a first receive path, and the method further includes: receiving, by the third receiver unit, a third radio frequency signal from the third antenna unit; and processing, by the first receive path of the third receiver unit, the third radio frequency signal and outputting a fifth reception signal in the first frequency band and a sixth reception signal in a third frequency band.

In some aspects, the techniques described herein relate to a method wherein the antenna system further includes a fourth antenna unit, the receiver system further includes a fourth receiver unit including a first receive path, and the method further includes: receiving, by the fourth receiver unit, a fourth radio frequency signal from the fourth antenna unit; and processing, by the first receive path of the fourth receiver unit, the fourth radio frequency signal and outputting a seventh reception signal in the first frequency band and an eighth reception signal in the third frequency band.

In some aspects, the techniques described herein relate to a method further including receiving, by a second receive path of the first receiver unit, a fifth radio frequency signal from the first antenna unit, and processing, by the second receive path of the first receiver unit, the fifth radio frequency signal and outputting a ninth reception signal in a fourth frequency band.

In some aspects, the techniques described herein relate to a method further including receiving, by a second receive path of the second receiver unit, a sixth radio frequency signal from the second antenna unit, and processing, by the second receive path of the second receiver unit, the sixth radio frequency signal and outputting a tenth reception signal in the fourth frequency band.

In some aspects, the techniques described herein relate to a method further including receiving, by a second receive path of the third receiver unit, a seventh radio frequency signal from the third antenna unit, and processing, by the second receive path of the third receiver unit, the seventh radio frequency signal and outputting an eleventh reception signal in a fifth frequency band.

In some aspects, the techniques described herein relate to a method further including receiving, by a second receive path of the fourth receiver unit, an eighth radio frequency signal from the fourth antenna unit, and processing, by the second receive path of the fourth receiver unit, the tenth radio frequency signal and outputting a twelfth reception signal in the fifth frequency band.

In some aspects, the techniques described herein relate to a method further including outputting, by the receiver system, the first, third, fifth and seventh reception signals in the first frequency band simultaneously for 4×4 DL-MIMO reception.

In some aspects, the techniques described herein relate to a method wherein the first frequency band is the B46 band, the second frequency band is the n79 band, the third frequency band is the 5 GHz WiFi band, the fourth frequency band is the n77 band, and the fifth frequency band is the 2.4 GHz WiFi band.

In some aspects, the techniques described herein relate to a method further including bandpass filtering, by a bandpass filter of the first receive path of the first receiver unit, the first radio frequency signal with a passband including the first and second frequency bands.

In some aspects, the techniques described herein relate to a method further including bandpass filtering, by a bandpass filter of the first receive path of the second receiver unit, the second radio frequency signal with a passband including the first and second frequency bands.

In some aspects, the techniques described herein relate to a method further including amplifying, by a first amplifier of the first receive path of the first receiver unit, the filtered first radio frequency signal in a frequency range including the first and second frequency band.

In some aspects, the techniques described herein relate to a method further including amplifying, by a first amplifier of the first receive path of the second receiver unit, the filtered second radio frequency signal in a frequency range including the first and second frequency band.

In some aspects, the techniques described herein relate to a method further including splitting, by a splitter of the first receive path of the first receiver unit, the filtered and amplified first radio frequency signal into the first and second reception signals.

In some aspects, the techniques described herein relate to a method further including splitting, by a splitter of the first receive path of the second receiver unit, the filtered and amplified second radio frequency signal into the third and fourth reception signals.

In some aspects, the techniques described herein relate to a method further including amplifying, by a second amplifier and a third amplifier of the first receiver unit, the first reception signal in the first frequency range and the second reception signal in the second frequency range, respectively.

In some aspects, the techniques described herein relate to a method further including amplifying, by a second amplifier and a third amplifier the first receive path of the second receiver unit, the third reception signal in the first frequency range and the fourth reception signal in the second frequency range, respectively.

In some aspects, the techniques described herein relate to a method further including bandpass filtering, by a bandpass filter of the second receive path of the first reception unit, the fifth radio frequency signal with a passband including the fourth frequency band, amplifying, by an amplifier of the second receive path of the first reception unit, the filtered fifth radio frequency signal, and outputting the amplified filtered fifth radio frequency signal as the ninth reception signal.

In some aspects, the techniques described herein relate to a method further including bandpass filtering, by a bandpass filter of the second receive path of the second reception unit, the sixth radio frequency signal with a passband including the fourth frequency band, amplifying, by an amplifier of the second receive path of the second reception unit. the filtered sixth radio frequency signal, and outputting the amplified filtered sixth radio frequency signal as the tenth reception signal.

In some aspects, the techniques described herein relate to a method further including amplifying, by an amplifier of the first receive path of the third reception unit, the third radio frequency signal, splitting, by a splitter of the first receive path of the third reception unit, the amplified third radio frequency signal into the fifth and sixth reception signals, and amplifying, by two amplifiers of the first receive path of the third reception unit, respectively the fifth and sixth reception signal.

In some aspects, the techniques described herein relate to a method further including amplifying, by an amplifier of the first receive path of the fourth reception unit, the fourth radio frequency signal, splitting, by a splitter of the first receive path of the fourth reception unit, the amplified fourth radio frequency signal into the seventh and eighth reception signals, and amplifying, by two amplifiers of the first receive path of the fourth reception unit, respectively the seventh and eighth reception signal.

In some aspects, the techniques described herein relate to a method further including outputting, by the receiver system, the first, third, fifth and seventh reception signals simultaneously for B46 4×4 DL-MIMO reception.

In some aspects, the techniques described herein relate to a packaged module including: surface mount components; an encapsulation structure; a package substrate including including pads formed from conductors disposed therein; a die including pads; wirebonds electrically connecting the pads of the die to the pads of the package substrate; and the die including a radio frequency front end system including a receiver system for receiving radio frequency signals from an antenna system, the receiver system having a first receiver unit configured to receive a first radio frequency signal from a first antenna unit of the antenna system, the first receiver unit including a first receive path; and the first receive path of the first receiver unit being adapted to process the first radio frequency signal and output a first reception signal in a first frequency band and a second reception signal in a second frequency band, the first and second frequency bands being adjacent to each other.

In some aspects, the techniques described herein relate to a packaged module including: surface mount components; an encapsulation structure; a package substrate including pads formed from conductors disposed therein; a die further including pads; wirebonds electrically connecting the pads of the die to the pads of the package substrate; and the die including a device with an antenna system including a first to fourth antenna unit; and a radio frequency front end system including a receiver system for receiving radio frequency signals from the antenna system, the radio frequency front end being coupled to the antenna system; and the receiver system including a first receiver unit configured to receive a first radio frequency signal from a first antenna unit of the antenna system, the first receiver unit including a first receive path, and the first receive path of the first receiver unit being adapted to process the first radio frequency signal and output a first reception signal in a first frequency band and a second reception signal in a second frequency band, the first and second frequency bands being adjacent to each other,

In some aspects, the techniques described herein relate to a packaged module including: surface mount components; an encapsulation structure; a package substrate including pads formed from conductors disposed therein; a die further including pads; wirebonds electrically connecting the pads of the die to the pads of the package substrate; and the die including a device with an antenna system including a first to fourth antenna unit; and a radio frequency front end system including a receiver system for receiving radio frequency signals from the antenna system, the radio frequency front end being coupled to the antenna system; and the receiver system including a first receiver unit configured to receive a first radio frequency signal from a first antenna unit of the antenna system, the first receiver unit including a first receive path, and the first receive path of the first receiver unit being adapted to process the first radio frequency signal and output a first reception signal in a first frequency band and a second reception signal in a second frequency band, the first and second frequency bands being adjacent to each other, the receiver system further including a second receiver unit configured to receive a second radio frequency signal from a second antenna unit of the antenna system, the second receiver unit including a first receive path, and the first receive path of the second receiver unit being adapted to process the second radio frequency signal and output a third reception signal in the first frequency band and a fourth reception signal in the second frequency band, the receiver system further including a third receiver unit configured to receive a third radio frequency signal from a third antenna unit of the antenna system, the third receiver unit including a first receive path, and the first receive path of the third receiver unit being adapted to process the third radio frequency signal and output a fifth reception signal in the first frequency band and a sixth reception signal in a third frequency band, and the receiver system further including a fourth receiver unit configured to receive a fourth radio frequency signal from a fourth antenna unit of the antenna system, the fourth receiver unit including a first receive path; and the first receive path of the fourth receiver unit being adapted to process the fourth radio frequency signal and output a seventh reception signal in the first frequency band and an eighth reception signal in the third frequency band.

In some aspects, the techniques described herein relate to a phone board, including the packaged module.

In some aspects, the techniques described herein relate to a phone board, including the packaged module.

In some aspects, the techniques described herein relate to a phone board, including the packaged module. 57538491

### BRIEF DESCRIPTION OF THE DRAWINGS

FIG. 1 is a diagram of an example dual connectivity network topology.

FIG. 2 is a schematic diagram of one example of a communication network.

FIG. 2A is a schematic diagram of one example of a communication link using carrier aggregation.

FIG. 2B illustrates various examples of carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 4A is a schematic diagram of an exemplary radio frequency (RF) system.

FIG. 4B is a schematic diagram of an exemplary RF system.

FIG. 4C is a schematic diagram of an exemplary RF system.

FIG. 5 is a schematic diagram of an exemplary RF system.

FIG. 6 is a schematic diagram of an exemplary RF system.

FIG. 7A is a schematic diagram of an exemplary ultrahigh band (UHB) transmit and receive module.

FIG. 7B is a schematic diagram of an exemplary high band (HB) transmit and receive module.

FIG. 7C is a schematic diagram of an exemplary mid band (MB) transmit and receive module.

FIG. 7D is a schematic diagram of an exemplary 2G power amplifier module according.

FIG. 7E is a schematic diagram of an exemplary uplink carrier aggregation and MIMO module.

FIG. 7F is an overview of frequency bands used for different purposes in wireless mobile communications;

FIG. 7G is a block diagram of a typical radio frequency, RF, front end, RFFE system, including a radio frequency, RF, front and, RFFE coupled to an antenna system ASY;

FIG. 7H is a block diagram showing more details of the RFFE system depicted in FIG. 7G;

FIG. 7I is an example of a two receiver units RU1, RU2 coupled to a first antenna unit AU1, and in particular, a typical design of with a first and second receiver unit RU-1, RU 2-1; RU 1-2, RU 2-2 for corresponding receive and transmit paths Tx1, Rx1 and Tx2, Rx2;

FIG. 7J is a more detailed block diagram of a typical Near Side UE and Far Side UE (user equipment) in which a plurality of receiver units for different bands as in FIG. 7H are coupled to a number of antennas ANT1-ANT6 for providing reception/transmission in the frequency bands illustrated in FIG. 7F, and in particular the usage of two receiver units RU1, RU2 for the n77 and n79 frequency bands and two receiver units RU3, RU4 for a typical B46 2×2 downlink-MIMO reception;

FIG. 7K is a block diagram similar to that in FIG. 7J which shows the usage of four receiver units RU1 to RU4 for realizing a full B46 band 4×4 downlink-MIMO according to an embodiment;

FIG. 7L is a more detailed block diagram of the receiver units RU1 to RU4 of FIG. 7K using amplifiers and filters, as well as switches for realizing the B46 4×4 downlink MIMO and in particular the connection to four antenna units AU1 to AU4;

FIG. 7M is a flowchart of a method according to an embodiment;

FIG. 7N is another flowchart of a method in accordance with another embodiment;

FIG. 70 is another flowchart of a method according to another embodiment;

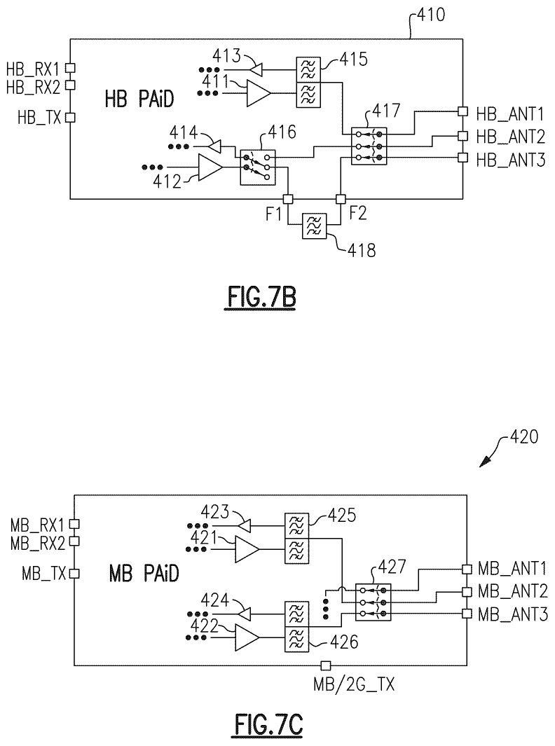

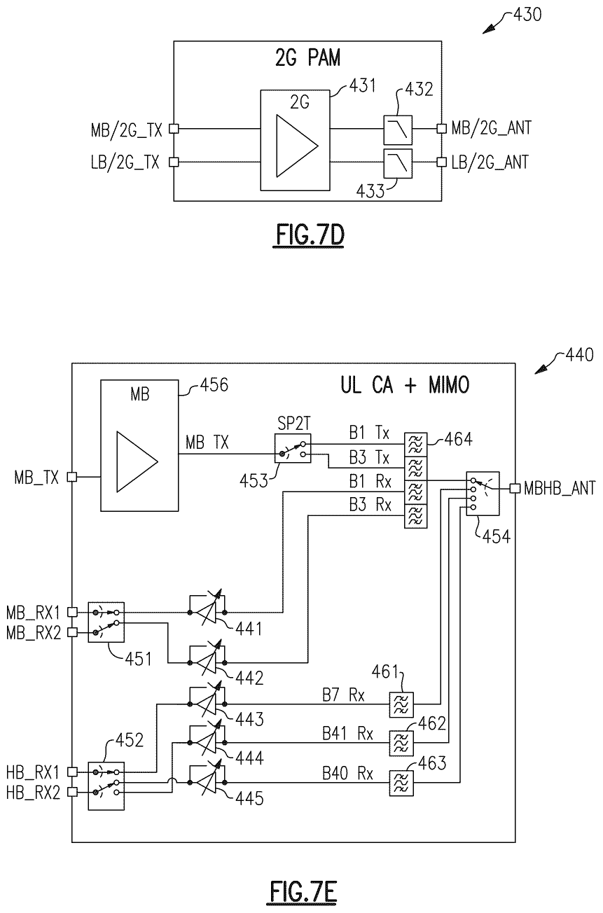

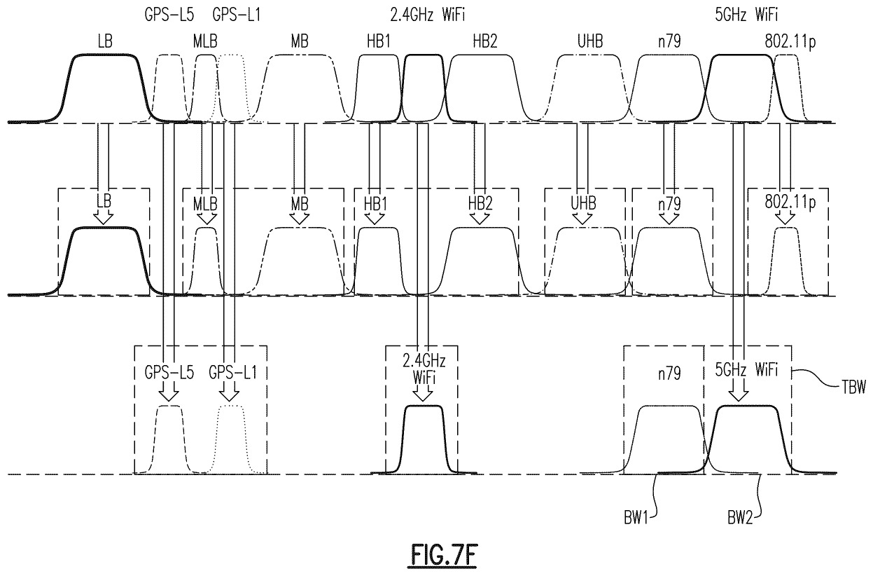

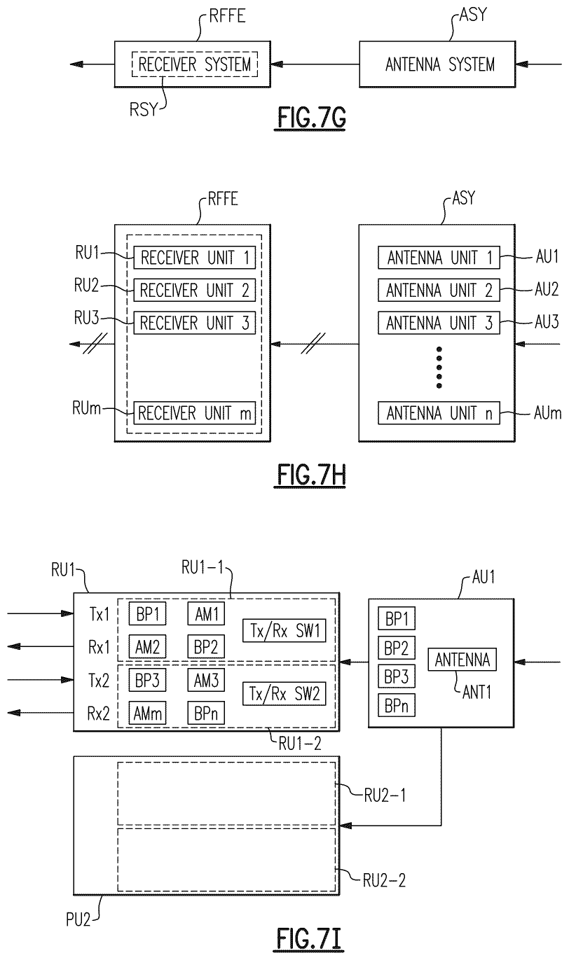

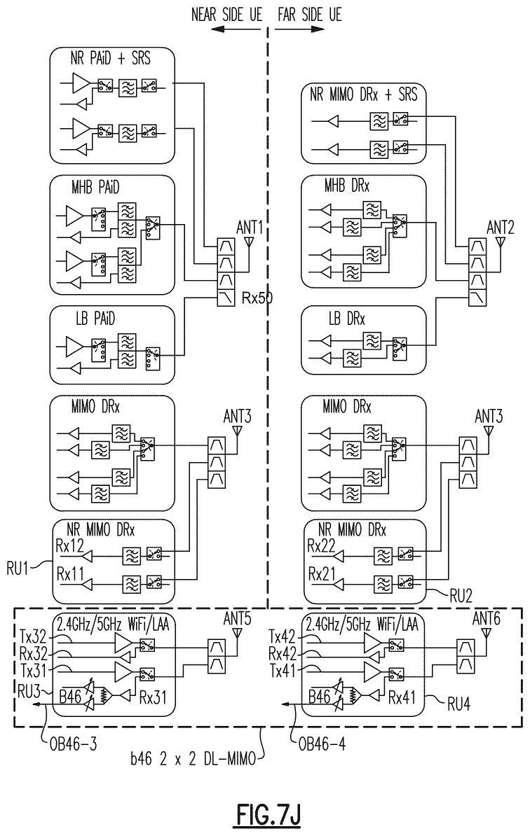

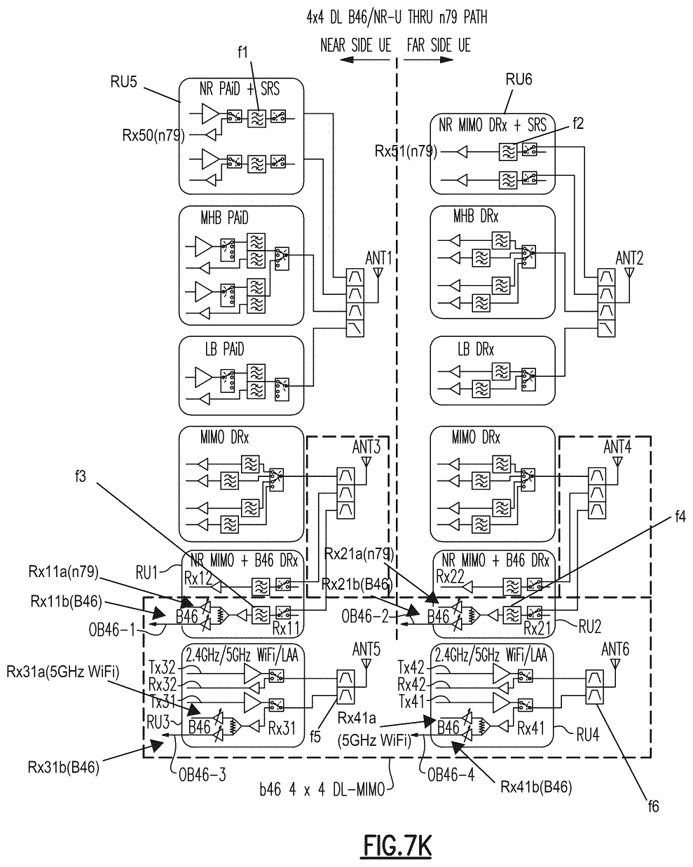

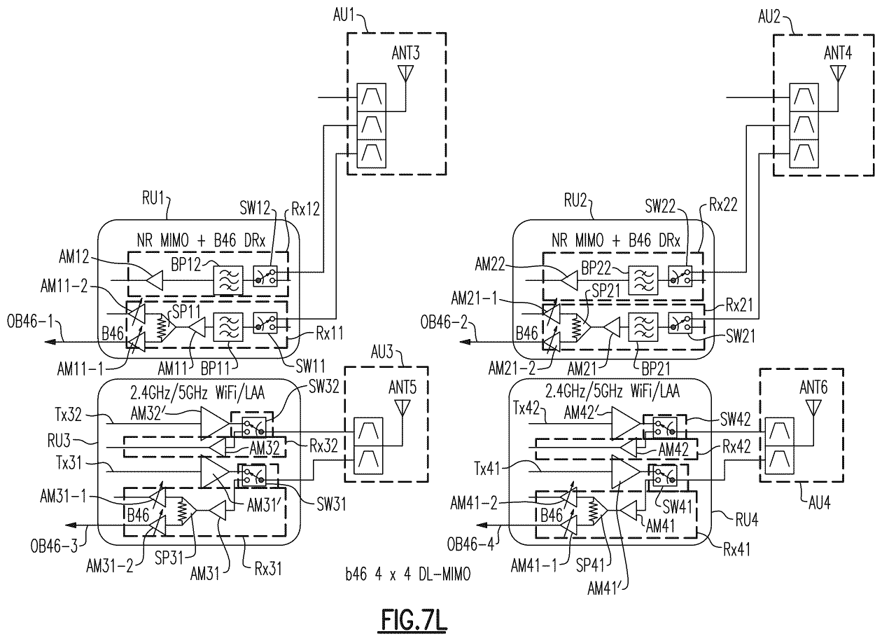

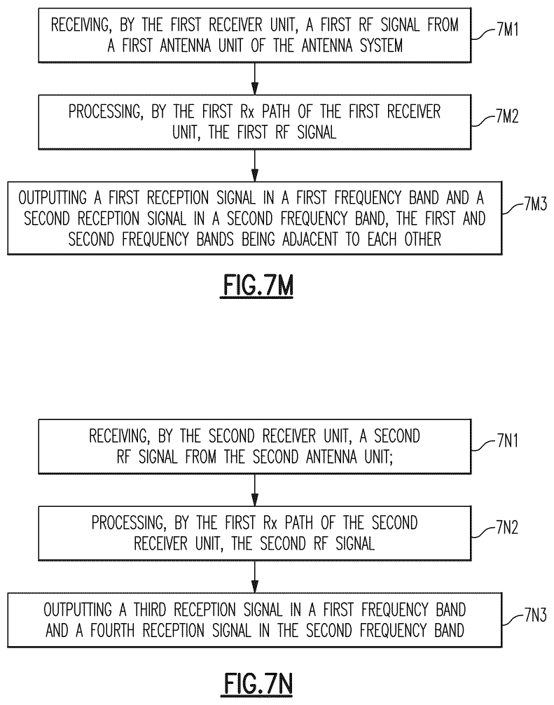

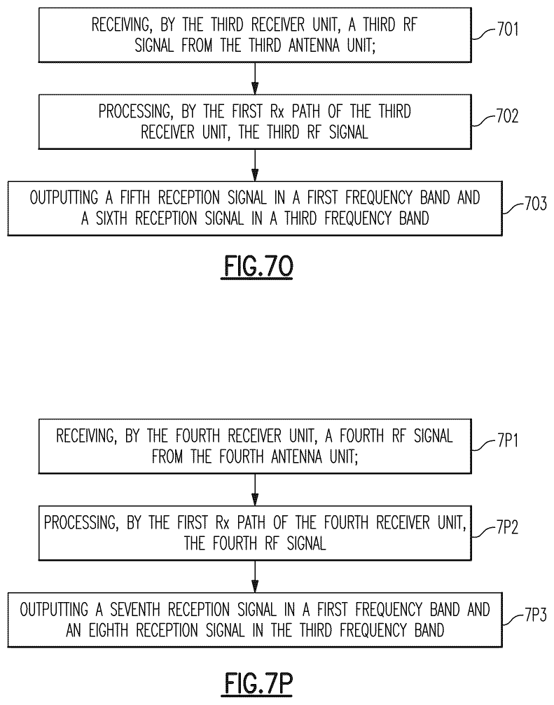

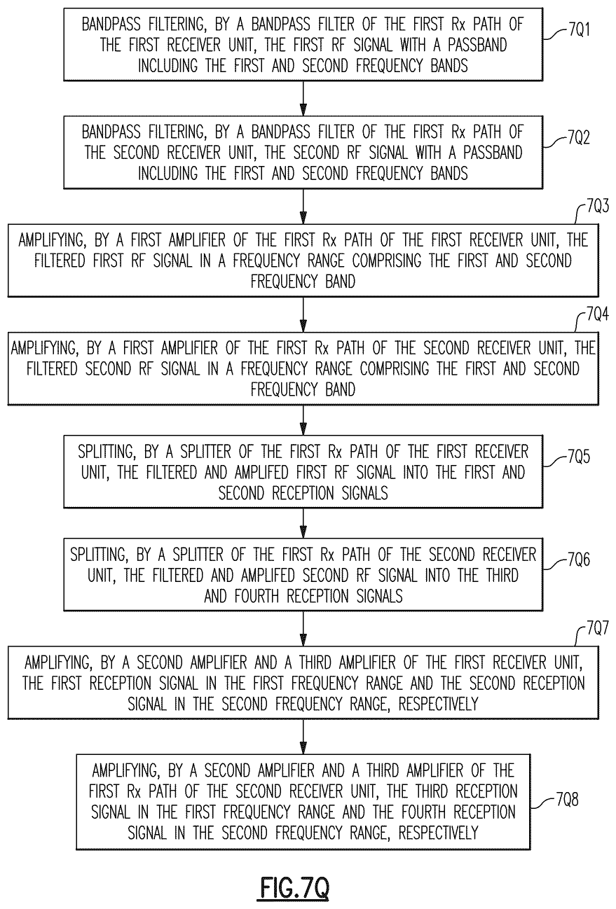

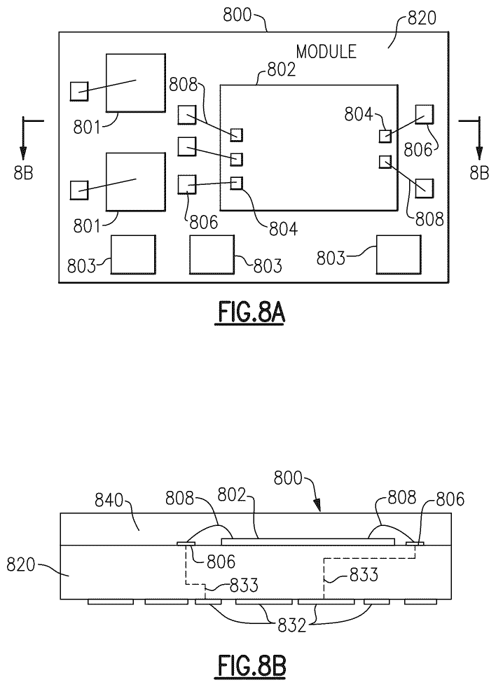

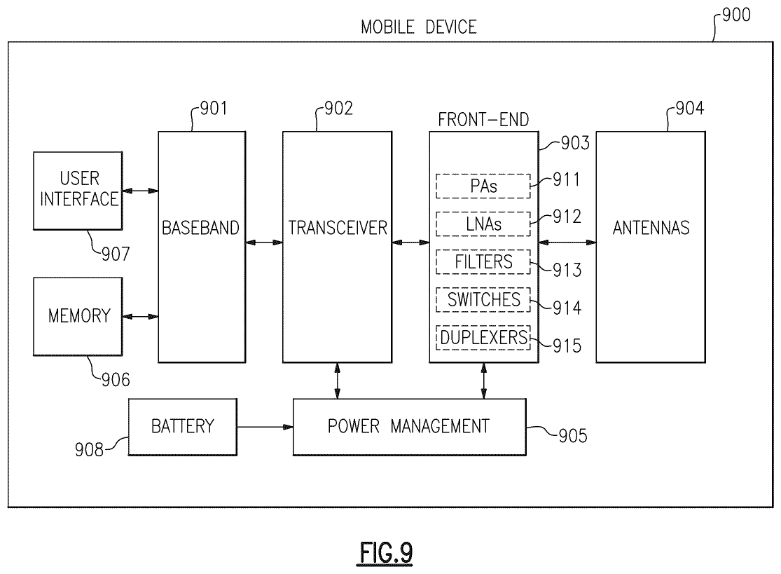

FIG. 7P is another flowchart of a method according to another embodiment;

FIG. 7Q is another flowchart of a method in accordance with an embodiment, in particular for carrying out the reception steps for the B46 4×4 downlink-MIMO as shown in FIG. 7L;

FIG. 8A is a schematic diagram of an exemplary packaged module.

FIG. 8B is a schematic diagram of a cross-section of the exemplary packaged module of FIG. 8A taken along the lines 8B-8B.

FIG. 9 is a schematic diagram of an exemplary mobile device.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IoT), Vehicle-to-Everything (V2X), and High Power User Equipment (HPUE).

3GPP introduced Phase 1 of fifth generation (5G) technology in Release 15, and developed 5G technology further in Release 16. Subsequent 3GPP releases will further evolve and expand 5G technology. 5G technology is also referred to herein as 5G New Radio (NR).

Preliminary specifications for 5G NR support a variety of features, such as communications over millimeter wave spectrum, beam forming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

### Dual Connectivity

With the introduction of the 5G NR air interface standards, 3GPP has allowed for the simultaneous operation of 5G and 4G standards in order to facilitate the transition. This mode can be referred to as Non-Stand-Alone (NSA) 5G operation or E-UTRAN New Radio-Dual Connectivity (EN-DC) and involves both 4G and 5G carriers being simultaneously transmitted from a user equipment (UE).

In certain EN-DC applications, dual connectivity NSA involves overlaying 5G systems onto an existing 4G core network. For dual connectivity in such applications, the control and synchronization between the base station and the UE can be performed by the 4G network while the 5G network is a complementary radio access network tethered to the 4G anchor. The 4G anchor can connect to the existing 4G network with the overlay of 5G data/control.

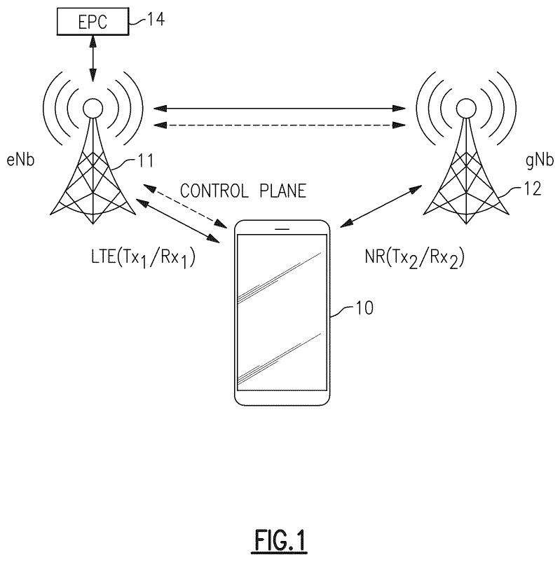

FIG. 1 is a diagram of an example dual connectivity network topology. This architecture can leverage LTE legacy coverage to ensure continuity of service delivery and the progressive rollout of 5G cells. A UE 10 can simultaneously transmit dual uplink LTE and NR carrier. The UE 10 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The CNB 11 can provide a connection with a core network, such as an Evolved Packet Core (EPC) 14. The gNB 12 can communicate with the core network via the eNB 11. Control plane data can be wireless communicated between the UE 10 and eNB 11. The CNB 11 can also communicate control plane data with the gNB 12. Control plane data can propagate along the paths of the dashed lines in FIG. 1. The solid lines in FIG. 1 are for data plane paths.

In the example dual connectivity topology of FIG. 1, any suitable combinations of standardized bands and radio access technologies (e.g., FDD, TDD, SUL, SDL) can be wirelessly transmitted and received. This can present technical challenges related to having multiple separate radios and bands functioning in the UE 10. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. This disclosure provides systems and methods of supporting EN-DC/NSA operation for concurrent UL transmission of both 4G (LTE anchor) and 5G signals, most often defined for inter-band dual connectivity and a kind of UL carrier aggregation

Architectures to support this include additional RF paths that support concurrent transmission. RF paths that are relatively close in frequency (within what is termed a “band group” i.e. LB, MB, HB, UHB, etc.) can be supported in certain embodiments on a single trace to an antennaplexer (that further merges signals on bands with larger frequency offsets). Such bands on shared traces are often ganged (i.e. trimmed or equilibrated to match each other) or switch-combined through a switch to be able to combine the signals onto that common trace. When this is the case, concurrent UL signals within that band group can be problematic because full power UL signals will be on common trace and create large intermodulation products that then often fall into the active Rx victim channels and cause large Rx desensitization. To support concurrency on the maximum number of antennas and/or reduce or eliminate IMD degradations, duplicated Tx RF paths can be designed into the architecture with sufficient carrier aggregation support across all band combinations. This advantageously allows for being able to transmit on separate antennas with sufficient RF isolation to address the IMD and Rx impairments.

Aspects of the disclosure are directed to EN-DC, although the systems and methods disclosed herein can be applied to other standards and technologies as well.

### Communication Network

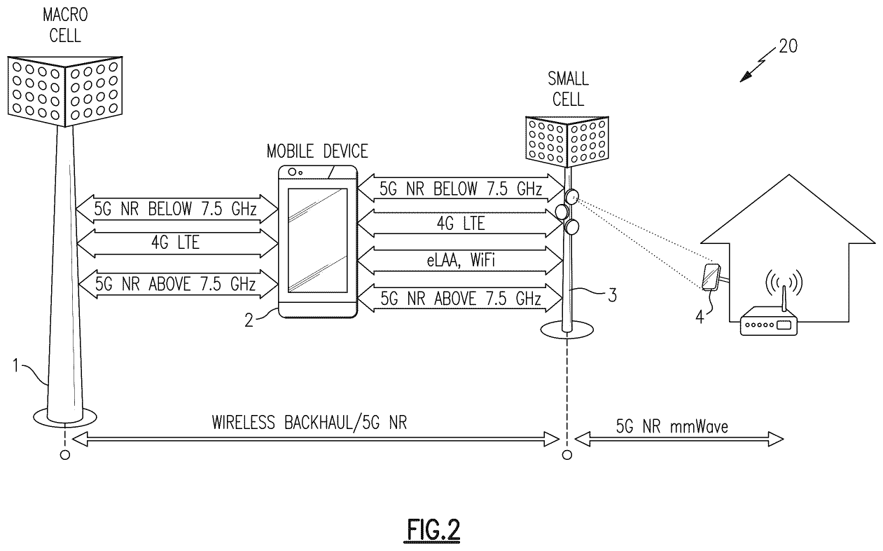

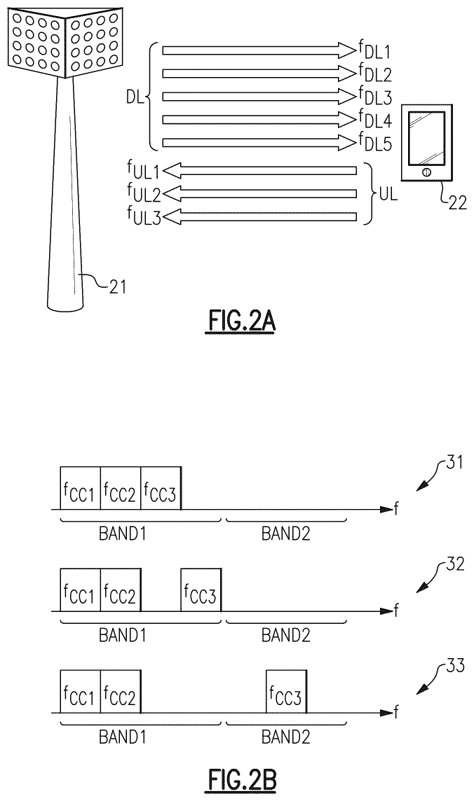

FIG. 2 is a schematic diagram of one example of a communication network 20. The communication network 20 includes a macro cell base station 1, a mobile device 2, a small cell base station 3, and a stationary wireless device 4.

The illustrated communication network 20 of FIG. 2 supports communications using a variety of technologies, including, for example, 4G LTE, 5G NR, and wireless local area network (WLAN), such as Wi-Fi. In the communication network 20, dual connectivity can be implemented with concurrent 4G LTE and 5G NR communication with the mobile device 2. Although various examples of supported communication technologies are shown, the communication network 20 can be adapted to support a wide variety of communication technologies.

Various communication links of the communication network 20 have been depicted in FIG. 2. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

As shown in FIG. 2, the mobile device 2 communicates with the macro cell base station 1 over a communication link that uses a combination of 4G LTE and 5G NR technologies. The mobile device 2 also communications with the small cell base station 3. In the illustrated example, the mobile device 2 and small cell base station 3 communicate over a communication link that uses 5G NR, 4G LTE, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

In certain implementations, the mobile device 2 communicates with the macro cell base station 2 and the small cell base station 3 using 5G NR technology over one or more frequency bands that are less than 7.5 Gigahertz (GHz) and/or over one or more frequency bands that are greater than 7.5 GHZ. For example, wireless communications can utilize Frequency Range 1 (FR1), Frequency Range 2 (FR2), or a combination thereof. In one embodiment, the mobile device 2 supports a HPUE power class specification.

The illustrated small cell base station 3 also communicates with a stationary wireless device 4. The small cell base station 3 can be used, for example, to provide broadband service using 5G NR technology. In certain implementations, the small cell base station 3 communicates with the stationary wireless device 4 over one or more millimeter wave frequency bands in the frequency range of 30 GHz to 300 GHz and/or upper centimeter wave frequency bands in the frequency range of 24 GHz to 30 GHz.

In certain implementations, the small cell base station 3 communicates with the stationary wireless device 4 using beamforming. For example, beamforming can be used to focus signal strength to overcome path losses, such as high loss associated with communicating over millimeter wave frequencies.

The communication network 20 of FIG. 2 includes the macro cell base station 1 and the small cell base station 3. In certain implementations, the small cell base station 3 can operate with relatively lower power, shorter range, and/or with fewer concurrent users relative to the macro cell base station 1. The small cell base station 3 can also be referred to as a femtocell, a picocell, or a microcell.

Although the communication network 20 is illustrated as including two base stations, the communication network 20 can be implemented to include more or fewer base stations and/or base stations of other types. As shown in FIG. 2, base stations can communicate with one another using wireless communications to provide a wireless backhaul. Additionally or alternatively, base stations can communicate with one another using wired and/or optical links.

The communication network 20 of FIG. 2 is illustrated as including one mobile device and one stationary wireless device. The mobile device 2 and the stationary wireless device 4 illustrate two examples of user devices or user equipment (UE). Although the communication network 20 is illustrated as including two user devices, the communication network 20 can be used to communicate with more or fewer user devices and/or user devices of other types. For example, user devices can include mobile phones, tablets, laptops, Internet of Things (IoT) devices, wearable electronics, and/or a wide variety of other communications devices.

User devices of the communication network 20 can share available network resources (for instance, available frequency spectrum) in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user device a unique code, space-divisional multiple access (SDMA) in which beamforming is used to provide shared access by spatial division, and non-orthogonal multiple access (NOMA) in which the power domain is used for multiple access. For example, NOMA can be used to serve multiple user devices at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user device. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with IoT applications.

The communication network 20 of FIG. 2 can be used to support a wide variety of advanced communication features, including, but not limited to eMBB, uRLLC, and/or mMTC.

A peak data rate of a communication link (for instance, between a base station and a user device) depends on a variety of factors. For example, peak data rate can be affected by channel bandwidth, modulation order, a number of component carriers, and/or a number of antennas used for communications.

For instance, in certain implementations, a data rate of a communication link can be about equal to M*B*log₂(1+S/N), where M is the number of communication channels, B is the channel bandwidth, and S/N is the signal-to-noise ratio (SNR).

Accordingly, data rate of a communication link can be increased by increasing the number of communication channels (for instance, transmitting and receiving using multiple antennas), using wider bandwidth (for instance, by aggregating carriers), and/or improving SNR (for instance, by increasing transmit power and/or improving receiver sensitivity).

5G NR communication systems can employ a wide variety of techniques for enhancing data rate and/or communication performance.

### Carrier Aggregation

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier fcc1, a second component carrier fcc2, and a third component carrier fcc3. Although FIG. 2B is illustrated in the context of aggregating three component carriers, carrier aggregation can be used to aggregate more or fewer carriers.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers fcc1, fcc2, and fcc3 that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers fcc1, fcc2, and fcc3 that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers fcc1 and fcc2 of a first frequency band BAND1 with component carrier fcc3 of a second frequency band BAND2.

With reference to FIGS. 2A and 2B, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as Wi-Fi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid Wi-Fi users and/or to coexist with Wi-Fi users. Enhanced license assisted access (eLAA) refers to an evolution of LAA that aggregates licensed and unlicensed spectrum for both downlink and uplink.

Carrier aggregation (CA) is one application/architecture where the concept of the present invention works well. However, the concept is more generally applicable, not just for CA modules.

### Multi-Input and Multi-Output (MIMO) Communications

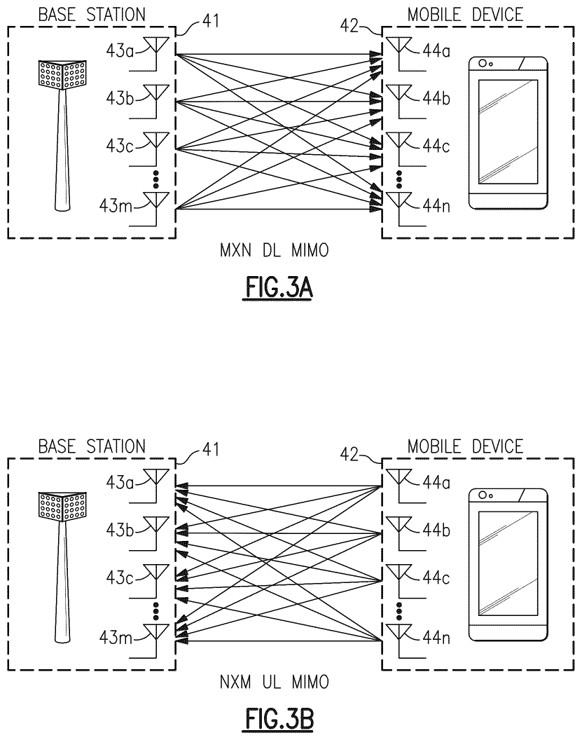

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of M×N DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of N×M UL MIMO.

By increasing the level or order of MIMO, bandwidth of an uplink channel and/or a downlink channel can be increased.

MIMO communications are applicable to dual connectivity and to communication links of a variety of types, such as FDD communication links and TDD communication links.

MIMO is one application/architecture where the concept of the present invention works well. However, the concept is more generally applicable, not just for MIMO modules.

### Examples of Radio Frequency Electronics

A radio frequency (RF) communication device can include multiple antennas for supporting wireless communications. Additionally, the RF communication device can include a radio frequency front-end (RFFE) system for processing signals received from and transmitted by the antennas. The RFFE system can provide a number of functions, including, but not limited to, signal filtering, controlling component connectivity to the antennas, and/or signal amplification.

RFFE systems can be used to handle RF signals of a wide variety of types, including, but not limited to, wireless local area network (WLAN) signals, Bluetooth signals, and/or cellular signals.

Additionally, RFFE systems can be used to process signals of a wide range of frequencies. For example, certain RFFE systems can operate using one or more low bands (for example, RF signal bands having a frequency content of 1 GHz or less, also referred to herein as LB), one or more mid bands (for example, RF signal bands having a frequency content between 1 GHz and 2.3 GHZ, also referred to herein as MB), one or more high bands (for example, RF signal bands having a frequency content between 2.3 GHz and 3 GHz, also referred to herein as HB), and one or more ultrahigh bands (for example, RF signal bands having a frequency content between 3 GHz and 6 GHz, also referred to herein as UHB).

RFFE systems can be used in a wide variety of RF communication devices, including, but not limited to, smartphones, base stations, laptops, handsets, wearable electronics, and/or tablets.

A RFFE system can be implemented to support a variety of features that enhance bandwidth and/or other performance characteristics of the RF communication device in which the RFFE system is incorporated.

In one example, a RFFE system is implemented to support carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels, for instance up to five carriers. Carrier aggregation includes contiguous aggregation, in which contiguous carriers within the same operating frequency band are aggregated. Carrier aggregation can also be non-contiguous, and can include carriers separated in frequency within a common band or in different bands.

In another example, a RFFE system is implemented to support multi-input and multi-output (MIMO) communications to increase throughput and enhance mobile broadband service. MIMO communications use multiple antennas for communicating multiple data streams over a single radio frequency channel. MIMO communications benefit from higher signal to noise ratio, improved coding, and/or reduced signal interference due to spatial multiplexing differences of the radio environment.

MIMO order refers to a number of separate data streams sent or received. For instance, a MIMO order for downlink communications can be described by a number of transmit antennas of a base station and a number of receive antennas for user equipment (UE), such as a mobile device.

RFFE systems that support carrier aggregation and multi-order MIMO can be used in RF communication devices that operate with wide bandwidth. For example, such RFFE systems can be used in applications servicing multimedia content streaming at high data rates.

Fifth Generation (5G) technology seeks to achieve high peak data rates above 10 Gbps. Certain 5G high-speed communications can be referred to herein as Enhanced Multi-user Broadband (eMBB).

To achieve eMBB data rates, RF spectrum available at millimeter wave frequencies (for instance, 30 GHz and higher) is attractive, but significant technical hurdles are present in managing the loss, signal conditioning, radiative phased array aspects of performance, beam tracking, test, and/or packaging in the handset associated with millimeter wave communications.

The RFFE systems herein can operate using not only LB, MB, and HB frequencies, but also ultrahigh band (UHB) frequencies in the range of about 3 GHz to about 6 GHz, and more particular between about 3.4 GHz and about 3.8 GHz. By communicating using UHB, enhanced peak data rates can be achieved without the technical hurdles associated with millimeter wave communications.

In certain implementations herein, UHB transmit and receive modules are employed for both transmission and reception of UHB signals via at least two primary antennas and at least two diversity antennas, thereby providing both 4×4 RX MIMO and 4×4 TX MIMO with respect to one or more UHB frequency bands, such as Band 42 (B42) (about 3.4 GHz to about 3.6 GHZ), Band 43 (B43) (about 3.6 GHz to about 3.8 GHZ), and/or Band 48 (B48) (about 3.55 GHz to about 3.7 GHZ). Furthermore, in certain configurations, the RFFE systems herein employ carrier aggregation using one or more UHB carrier frequencies, thereby providing flexibility to widen bandwidth for uplink and/or downlink communications.

By enabling high-order MIMO and/or carrier aggregation features using UHB spectrum, enhanced data rates can be achieved. Additionally, rather than using dedicated 5G antennas and a separate transceiver, shared antennas and/or a shared transceiver (for example, a semiconductor die including a shared transceiver fabricated thereon) can be used for both 5G UHB communications and 4G/LTE communications associated with HB, MB, and/or LB. Thus, 4G/LTE communications systems can be extended to support sub-6 GHz 5G capabilities with a relatively small impact to system size and/or cost.

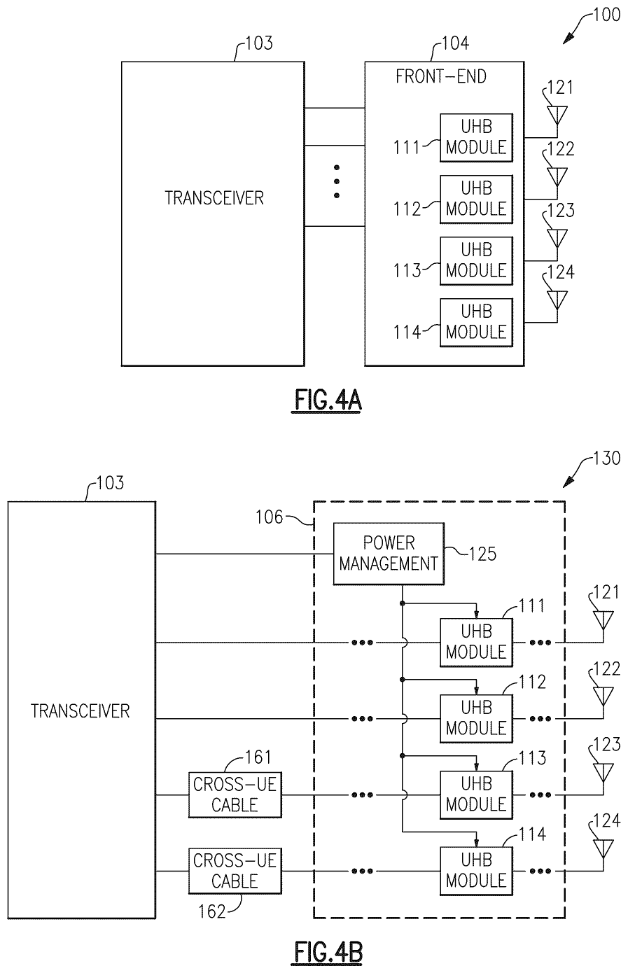

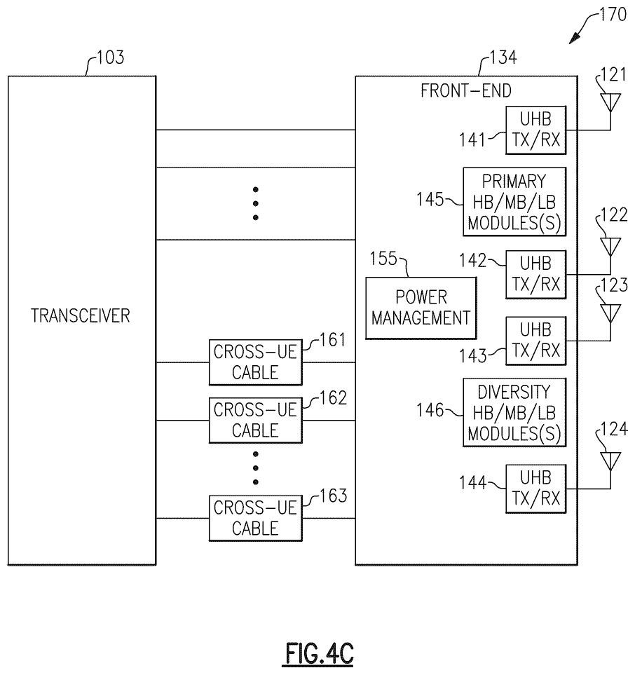

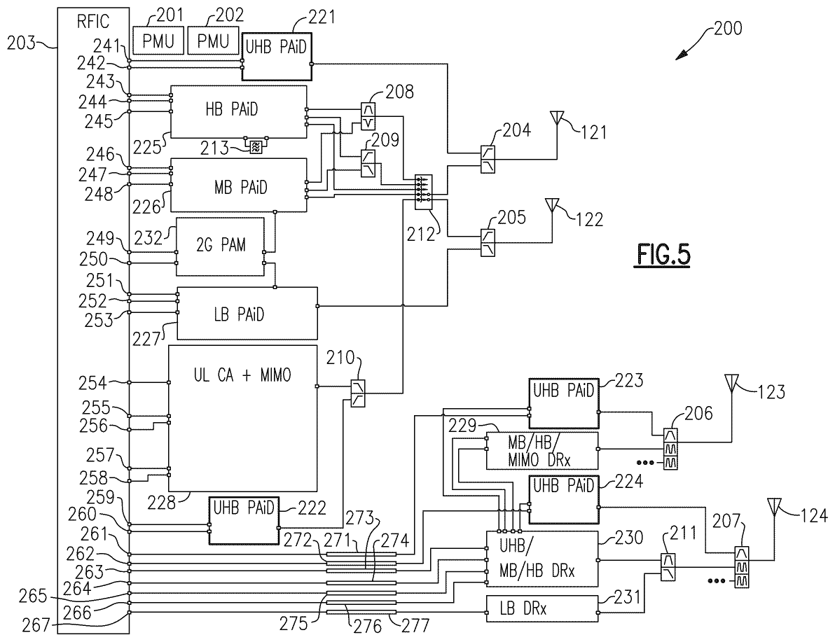

FIG. 4A is a schematic diagram of a RF system 100. The RF system 100 includes a radio frequency integrated circuit (RFIC) or transceiver 103, a front-end system 104 and antennas 121-124. In certain implementations, the antenna 121 is a first primary antenna, the antenna 122 is a second primary antenna, the antenna 123 is a first diversity antenna, and the antenna 124 is a second diversity antenna.

Although the RF system 100 is depicted as including certain components, other implementations are possible, including, but not limited to, implementations using other numbers of antennas, different implementations of components, and/or additional components.

The front-end system 104 includes a first UHB module 111, a second UHB module 112, a third UHB module 113, and a fourth UHB module 114. The front-end system 104 further includes separate antenna terminals for coupling to each of the antennas 121-124.

Thus, the front-end system 104 of FIG. 4A includes multiple UHB modules for supporting communications of UHB signals across multiple antennas. For example, in certain implementations, the UHB modules 111-114 are configured to transmit and receive UHB signals via the antennas 121-124, respectively. Accordingly, broadband communications via UHB frequency carriers can be achieved.

For clarity of the figures, the front end system 104 is depicted as including only the UHB modules 111-114. However, the front end system 104 typically includes additionally components and circuits, for example, modules associated with LB, MB, and/or HB cellular communications. Furthermore, modules can be included for Wi-Fi, Bluetooth, and/or other non-cellular communications.

FIG. 4B is a schematic diagram of a RF system 130. The RF system 130 includes a transceiver 103, a front-end system 106, a first primary antenna 121, a second primary antenna 122, a first diversity antenna 123, a second diversity antenna 124, a first cross-UE cable 161, and a second cross-UE cable 162. As shown in FIG. 4B, the front-end system 106 includes a first UHB module 111, a second UHB module 112, a third UHB module 113, a fourth UHB module 114, and a power management circuit 125. The front-end system 106 further includes a first primary antenna terminal for coupling to the first primary antenna 121, a second primary antenna terminal for coupling to the second primary antenna 122, a first diversity antenna terminal for coupling to the first diversity antenna 123, and a second diversity antenna terminal for coupling to the second diversity antenna 124.

As shown in FIG. 4B, the first UHB module 111 and the second UHB module 112 communicate using the first primary antenna 121 and the second primary antenna 122, respectively, and are connected to the transceiver 103 without the use of cross-UE cables. Additionally, the third UHB module 113 and the fourth UHB module 114 communicate using the first diversity antenna 123 and the second diversity antenna 124, respectively, and are connected to the transceiver 103 using the first cross-UE cable 161 and the second cross-UE cable 162, respectively.

To reduce the statistical correlation between received signals, the primary antennas 121-122 and the diversity antennas 123-124 can be separated by a relatively large physical distance in the RF system 130. For example, the diversity antennas 123-124 can be positioned near the top of the device and the primary antennas 121-122 can be positioned near the bottom of the device, or vice-versa. Additionally, the transceiver 103 can be positioned near the primary antennas 121-122 and primary modules to enhance performance of primary communications.

Accordingly, in certain implementations, the UHB modules 113-114 and diversity antennas 123-124 can be located at relatively far physical distance from the transceiver 103 and connected to the transceiver 103 via cross-UE cables 161-162, respectively.

In the illustrated example, the front-end system 106 further includes a shared power management circuit 125 used to provide a supply voltage, such as a power amplifier supply voltage, to the UHB modules 111-114.

Providing power to the UHB modules 111-114 using the shared power management circuit 125 can provide a number of advantages, including, for example, high integration, reduced component count, and/or lower cost.

In certain implementations, the shared power management circuit 125 operates using average power tracking (APT), in which the voltage level of the supply voltage provided by the shared power management circuit 125 is substantially fixed over a given communication time slot. In certain implementations, the supply voltage has a relatively high voltage, and thus operates with a corresponding low current. Thus, although the UHB modules 111-114 can be distributed across the device over relatively wide distances and connected using resistive cables and/or conductors, power or I<2>*R losses can be relatively small.

Accordingly, the shared power management circuit 125 can provide high integration with relatively low power loss.

FIG. 4C is a schematic diagram of a RF system 170 according to another example. The RF system 170 includes a transceiver 103, a front-end system 134, a first primary antenna 121, a second primary antenna 122, a first diversity antenna 123, a second diversity antenna 124, a first cross-UE cable 161, a second cross-UE cable 162, and a third cross-UE cable 163.

The illustrated RF system 170 is used to transmit and receive signals of a wide variety of frequency bands, including LB, MB, HB, and UHB cellular signals. For example, the RF system 170 can process one or more LB signals having a frequency content of 1 GHz or less, one or more MB signals having a frequency content between 1 GHz and 2.3 GHz, one or more HB signals having a frequency content between 2.3 GHZ and 3 GHZ, and one or more UHB signals have a frequency content between 3 GHz and 6 GHz. Examples of LB frequencies include, but are not limited to Band 8, Band 20, and Band 26. Examples of MB frequencies include, but are not limited to, Band 1, Band 3, Band 4, and Band 66. Examples of HB frequencies include, but are not limited to, Band 7, Band 38, and Band 41. Examples of UHB frequencies include, but are not limited to, Band 42, Band 43, and Band 48.

The illustrated front-end system 134 includes one or more primary modules 145 used for transmitting and receive HB, MB, and/or LB signals via the primary antennas 121-122. Although illustrated as a single block, the primary modules 145 can include multiple modules collectively used to transmit and receive HB, MB, and/or LB signals via the first primary antenna 121 and the second primary antenna 122. Additionally, in certain implementations, the first primary antenna 121 and the second primary antenna 122 can be used for communicating over certain frequency ranges. For instance, in one example, the second primary antenna 122 supports LB communications but the first primary antenna 121 does not support LB communications.

With continuing reference to FIG. 4C, the front-end system 134 further includes one or more diversity modules 146 used for receiving HB, MB, and/or LB diversity signals via the diversity antennas 123-124. In certain implementations, the diversity modules 146 operate to receive but not transmit diversity signals. In other implementations, the diversity modules 146 also can be used for transmitting HB, MB, and/or LB signals.

In the illustrated example, the front-end system 134 further includes a first UHB transmit and receive (TX/RX) module 141 electrically coupled to the first primary antenna 121, a second UHB transmit and receive module 142 electrically coupled to the second primary antenna 122, a third UHB transmit and receive module 143 electrically coupled to the first diversity antenna 123, and a fourth UHB transmit and receive module 144 electrically coupled to the second diversity antenna 124. The front-end system 134 further includes a first primary antenna terminal for coupling to the first primary antenna 121, a second primary antenna terminal for coupling to the second primary antenna 122, a first diversity antenna terminal for coupling to the first diversity antenna 123, and a second diversity antenna terminal for coupling to the second diversity antenna 124.

In the illustrated example, the UHB transmit and receive modules 141-144 support transmit and receive of one or more UHB frequency bands, including, but not limited to, Band 42, Band 43, and/or Band 48.

Accordingly, the UHB transmit and receive modules 141-144 can be used to support 4×4 RX MIMO for UHB, 4×4 TX MIMO for UHB, and/or carrier aggregation using one or more UHB frequency carriers. Carrier aggregation using UHB frequency spectrum can include not only carrier aggregation using two or more UHB frequency carriers, but also carrier aggregation using one or more UHB frequency carriers and one or more non-HB frequency carriers, such as HB and/or MB frequency carriers.

In certain communications networks, a user demand for high downlink data rates can exceed a demand for high uplink data rates. For instance, UEs of the network, such as smartphones, may desire high speed downloading of multimedia content, but uploading relatively little data to the cloud. This in turn, can lead to the network operating with a relatively low UL to DL time slot ratio and limited opportunities for UL communications.

However, DL data rate of a network can be limited or bottlenecked by an UL data rate. For instance, in certain networks, UL data rate must stay within about 5% of DL data rate to support control, acknowledgement, and other overhead associated with the communication link. Accordingly, higher DL data rates can be achieved by increasing UL data rate.

The front-end system 134 of FIG. 4C includes UHB transmit and receive modules that advantageously support both transmission and reception of UHB signals. Accordingly, broadband UL communications via UHB frequency carriers can be achieved, thereby enhancing UL data rate and providing sufficient UL bandwidth to support overhead associated with very high data rate DL communications.

The illustrated RF system 170 advantageously includes four transmit capable UHB transmit and receive modules 141-144 coupled to the antennas 121-124, respectively. Thus, both transmit and receive are equally available at each of the antennas 121-124 for UHB communications. Thus, antenna swap can be accomplished without a swap switch to redirect a trace or route. For example, antenna selection can be achieved by controlling whether or not each UHB transmit and receive module is transmitting or receiving. Accordingly, the RF system 170 achieves antenna swap functionality for UHB without using any antenna swap switch.

In the illustrated example, a shared or common transceiver 103 is used for both 4G/LTE communications using HB, MB, and LB frequencies, and also for UHB communications supporting sub-6 GHz 5G. Thus, rather than using a separate or dedicated 5G front-end and antenna interface, the shared transceiver 103 is used for both 4G/LTE communications via HB, MB, and LB frequencies and 5G UHB communications.

The illustrated RF system 170 also employs diversity communications to enhance performance. To reduce the correlation between received signals, the primary antennas 121-122 and the diversity antennas 123-124 can be separated by a relatively large physical distance in the RF system 170. For example, the diversity antennas 123-124 can be positioned near the top of the device and the primary antennas 121-122 can be positioned near the bottom of the device or vice-versa. Additionally, the transceiver 103 can be positioned near the primary antennas 121-122 and primary modules to enhance performance of primary communications.

Accordingly, in certain implementations, the UHB transmit and receive modules 143-144, the diversity module(s) 146, and the diversity antennas 123-124 can be located at relatively far physical distance from the transceiver 103 and connected to the transceiver 103 via cross-UE cables 161-163. Additionally, the UHB transmit and receive modules 141-144 can be distributed and/or placed in remote locations around the RF system 170. Although three cross-UE cables are illustrated, more or fewer cross-UE cables can be included as indicated by the ellipsis.

In the illustrated example, the front-end system 134 further includes a power management circuit 155. In certain implementations, the power management circuit 155 is used to provide a supply voltage, such as a power amplifier supply voltage, which is shared by multiple components including the UHB transmit and receive modules 141-144.

Providing power to the UHB transmit and receive modules 141-144 using a shared power management circuit can provide a number of advantages, including, for example, high integration, reduced component count, and/or lower cost.

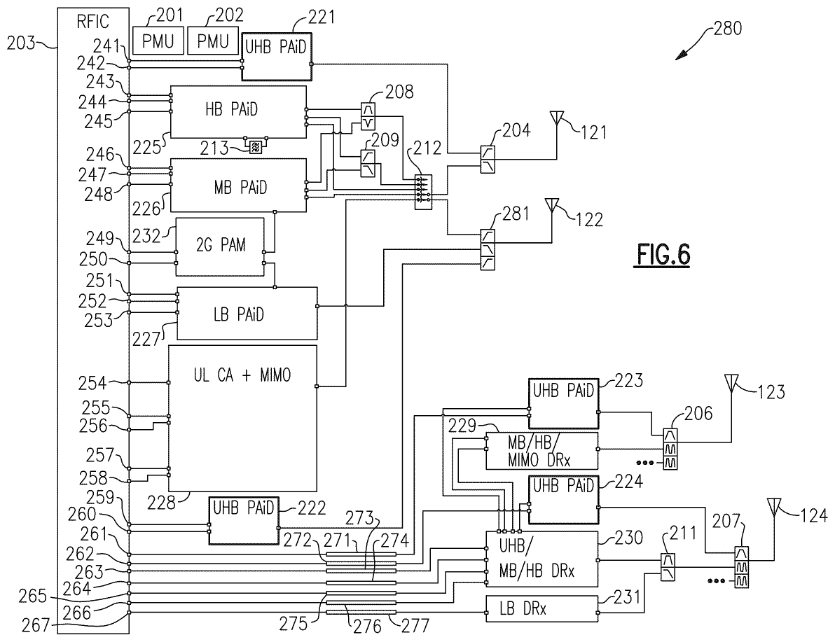

FIG. 5 is a schematic diagram of a RF system 200. The RF system 200 includes a first primary antenna 121, a second primary antenna 122, a first diversity antenna 123, a second diversity antenna 124, a first power management unit (PMU) 201, a second PMU 202, a transceiver or RFIC 203, a first primary antenna diplexer 204, a second primary antenna diplexer 205, a first diversity antenna triplexer 206, a second diversity antenna triplexer 207, a first HB/MB diplexer 208, a second HB/MB diplexer 209, a MIMO/UHB diplexer 210, a diversity diplexer 211, a multi-throw switch 212, a HB TDD filter 213, a first UHB power amplifier with integrated duplexer (PAID) module 221, a second UHB PAID module 222, a third UHB PAID module 223, a fourth UHB PAID module 224, an HB PAID module 225, an MB PAID module 226, an LB PAID module 227, an UL CA and MIMO module 228, an MB/HB MIMO diversity receive (DRx) module 229, a UHB/MB/HB DRx module 230, an LB DRx module 231, a 2G power amplifier module (PAM) 232, a first cross-UE cable 271, a second cross-UE cable 272, a third cross-UE cable 273, a fourth cross-UE cable 274, a fifth cross-UE cable 275, a sixth cross-UE cable 276, and a seventh cross-UE cable 277.

The RF system 200 includes a RFFE that provides full sub-6 GHz 5G capability provided by four remote placements of UHB PAID modules 221-224. Although one specific example of an RF system with UHB modules is shown, the teachings herein are applicable to RF electronics implemented in a wide variety of ways. Accordingly, other implementations are possible.

As shown in FIG. 5, the first UHB PAID module 221 is coupled to the first primary antenna 121, and the second UHB PAID module 222 is coupled to the second primary antenna 122. Additionally, the third UHB PAID module 223 is coupled to the first diversity antenna 123, and the fourth UHB PAID module 224 is coupled to the second diversity antenna 124. Accordingly, one UHB PAID module is included for each of the four antennas of this example.

In certain implementations, the UHB PAID modules 221-224 support transmit and receive of one or more UHB frequency bands, including, but not limited to, Band 42, Band 43, and/or Band 48.

The RF system 200 of FIG. 5 supports 4×4 RX MIMO for UHB, 4×4 TX MIMO for UHB, and carrier aggregation (CA) with 4G and/or 5G bands.

As will be described below, the first PMU 201 and the second PMU 202 are used to provide power management to certain modules. For clarity of the figures, a connection from each PMU to the modules it powers is omitted from FIG. 5 to avoid obscuring the drawing.

In the illustrated example, the first PMU 201 operates as a shared power management circuit for the first UHB PAID module 221, the second UHB PAID module 222, the third UHB PAID module 223, and the fourth UHB PAID module 224. The first PMU 201 can be used, for example, to control a power supply voltage level of the UHB PAID modules' power amplifiers. Additionally, the first PMU 201 is also shared with the HB PAID module 225, which transmits and receives HB signals on the first primary antenna 121 and the second primary antenna 122, and with the UL CA and MIMO module 228 used for enhancing MIMO order and a maximum number of supported carriers for carrier aggregation. Thus, the first PMU 201 provides a shared power supply voltage to the UHB PAID modules 221-224, the HB PAID module 225, and the UL CA and MIMO module 228, in this example.

By sharing the first PMU 201 in this manner, a common power management scheme, such as fixed supply wide bandwidth average power tracking (APT), can be advantageously used for the modules.

In the illustrated example, the second PMU 202 generates a shared power supply voltage used by the MB PAID 226 and by the LB PAID module 227.

In certain implementations, the diversity modules and diversity antennas can be located at relatively far physical distance from the RFIC 203, and connected to the RFIC 203 via cross-UE cables 271-277. Thus, the UHB PAID modules 221-224 can be placed in remote locations around the UE phone board.

In certain examples herein, a PMU is shared between at least one UHB module and at least one a HB module or a MB module.

The illustrated RF system 200 of FIG. 5 advantageously includes four transmit capable UHB PAID modules 221-224 coupled to four separate antennas 121-124, respectively, and thus both transmit and receive are equally available at each antenna for UHB communications.

Accordingly, antenna swap can be accomplished without a swap switch to redirect a trace or route. For example, antenna selection can be achieved by controlling which UHB power amplifier(s) of the UHB PAID modules 221-224 are enabled. Similarly, with respect to receive, the antenna selection can be made by controlling which UHB low noise amplifier(s) of the UHB PAID modules 221-224 are turned on. Thus, in this example, antenna swap functionality is achieved without using any antenna swap switch.

In certain implementations, the RFIC of FIG. 5 can provide beam steering and/or different data streams through digital baseband control of a relative phase difference between signals provided to the UHB PAID modules 221-224.

In the illustrated example, the first primary antenna diplexer 204 operates to diplex between UHB frequencies and MB/HB frequencies. Additionally, the second primary antenna diplexer 205 operates to diplex between MB/HB/UHB frequencies and LB frequencies. Furthermore, the first diversity antenna triplexer 206 operates to triplex between UHB frequencies, MB/HB frequencies, and 2 GHz/5 GHz Wi-Fi frequencies. Additionally, the second diversity antenna triplexer 207 operates to triplex between UHB frequencies, LB/HB/MB frequencies, and 2 GHz/5 GHz Wi-Fi frequencies. For clarity of the figures, Wi-Fi modules connected to the first diversity antenna triplexer 206 and to the second diversity antenna triplexer 207 are not illustrated.

With continuing reference to FIG. 5, the first HB/MB diplexer 208 operates to diplex between a first group of HB frequencies (for example, Band 30 and/or Band 40) and MB frequencies. Additionally, the second HB/MB diplexer 209 operates to diplex between a second group of HB frequencies (for example, Band 7 and/or Band 41) and MB frequencies. Furthermore, the MIMO/UHB diplexer 210 operates to diplex between MB/HB frequencies and UHB frequencies. Additionally, the diversity diplexer 211 operates to diplex between MB/HB frequencies and LB frequencies.

In the illustrated example, the RFIC 203 includes a first RX UHB terminal 241, a first TX UHB terminal 242, a first RX HB terminal 243, a second RX HB terminal 244, a TX HB terminal 245, a first RX MB terminal 246, a second RX MB terminal 247, a first TX MB terminal 248, a 2G TX MB terminal 249, a 2G RX MB terminal 250, a first RX LB terminal 251, a second RX LB terminal 252, a TX LB terminal 253, a second TX MB terminal 254, a third RX MB terminal 255, a fourth RX MB terminal 256, a third RX HB terminal 257, a fourth RX HB terminal 258, a second RX UHB terminal 259, a second TX UHB terminal 260, a third TX UHB terminal 261, a fourth TX UHB terminal 262, a first shared RX UHB/HB terminal 263, a second shared RX UHB/HB terminal 264, a first shared RX MB/HB terminal 265, a second shared RX MB/HB terminal 266, and an LB RX terminal 267. As shown in FIG. 5, certain terminals are shared across multiple bands to share resources and/or reduce signal routes (for instance, to use fewer cross-UE cables).

Although one example of a RF system 200 is shown in FIG. 5, the teachings herein are applicable to RF systems implemented in a wide variety of ways.

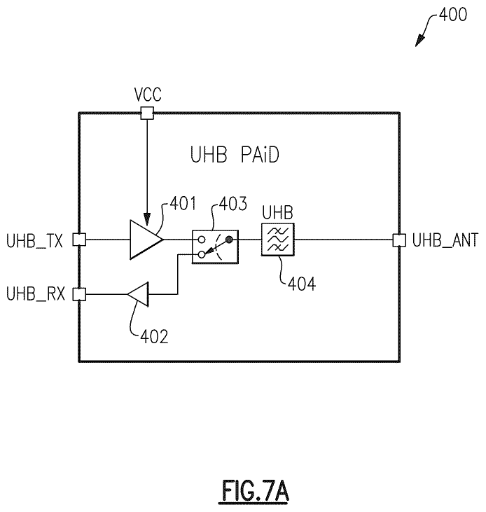

FIG. 6 is a schematic diagram of an RF system 280 according to another example. The RF system 280 includes a first primary antenna 121, a second primary antenna 122, a first diversity antenna 123, a second diversity antenna 124, a first PMU 201, a second PMU 202, a RFIC 203, a primary antenna diplexer 204, a primary antenna triplexer 281, a first diversity antenna triplexer 206, a second diversity antenna triplexer 207, a first HB/MB diplexer 208, a second HB/MB diplexer 209, a diversity diplexer 211, a multi-throw switch 212, an HB TDD filter 213, a first UHB PAID module 221, a second UHB PAID module 222, a third UHB PAID module 223, a fourth UHB PAID module 224, an HB PAID module 225, an MB PAID module 226, an LB PAID module 227, an UL CA and MIMO module 228, an MB/HB MIMO DRx module 229, a UHB/MB/HB DRx module 230, an LB DRx module 231, a 2G PAM 232, and first to seventh cross-UE cables 271-277, respectively.

The RF system 280 of FIG. 6 is similar to the RF system 200 of FIG. 5, except that the RF system 280 of FIG. 6 includes the primary antenna triplexer 281 rather than the second primary antenna diplexer 205, and omits the MIMO/UHB diplexer 210 in favor of connecting the second UHB PAID module 222 to the second primary antenna 122 by way of the primary antenna triplexer 281.

Implementing the RF system 280 in this manner connects the second UHB PAID module 222 to the second primary antenna 122 with lower loss relative to the example of FIG. 5. Thus, the RF system 280 of FIG. 6 has lower insertion loss for certain UHB signal paths, which can enhance the performance of certain CA combinations and/or when operating using UHB MIMO communications.

FIG. 7A is a schematic diagram of a UHB transmit and receive module 400 according to one example. The UHB transmit and receive module 400 operates to generate a UHB signal for transmission and to process a UHB signal received from an antenna.

The UHB transmit and receive module 400 illustrates one implementation of a UHB module suitable for incorporation in a RF system, such as any of the RF systems of FIGS. 4A-6. Although the UHB transmit and receive module 400 illustrates one implementation of a UHB module, the teachings herein are applicable to RF electronics including UHB modules implemented in a wide variety of ways. Accordingly, other implementations of UHB modules are possible, such as UHB modules with more or fewer pins, different pins, more or fewer components, and/or a different arrangement of components.

The UHB transmit and receive module 400 includes a power amplifier 401, a low noise amplifier 402, a transmit/receive switch 403, and a UHB filter 404, which is used to pass one or more UHB bands, for instance, Band 42 (B42), Band 43 (B43), and/or Band 48 (B48). The UHB transmit and receive module 400 further includes a variety of pins, including a UHB_TX pin for receiving a UHB transmit signal for transmission, a UHB_RX pin for outputting a UHB receive signal, a UHB_ANT pin for connecting to an antenna, and a VCC pin for receiving a supply voltage for powering at least the power amplifier 401. In certain implementations, the VCC pin receives a shared supply voltage from a power management circuit (for example, a PMU) shared by multiple modules.

The illustrated UHB transmit and receive module 400 provides both transmit and receive functionality for UHB signals. Thus, when four instantiations of the UHB transmit and receive module 400 are coupled directly or indirectly to four antennas, both 4×4 RX MIMO for UHB and 4×4 TX MIMO for UHB can be achieved. Additionally, the UHB transmit and receive modules can be used to support carrier aggregation for UL and/or DL using one or more UHB carrier frequencies.

FIG. 7B is a schematic diagram of a HB transmit and receive module 410 according to one example.

The RF systems disclosed herein can include one or more implementations of the HB transmit and receive module 410. Although the HB transmit and receive module 410 illustrates one implementation of an HB module, the teachings herein are applicable to RF electronics including HB modules implemented in a wide variety of ways as well as to RF electronics implemented without HB modules.

The HB transmit and receive module 410 includes a first power amplifier 411 for FDD communications, a second power amplifier 412 for TDD communications, a first low noise amplifier 413 for FDD communications, a second low noise amplifier 414 for TDD communications, an FDD duplexer 415, a transmit/receive switch 416, and a multi-throw switch 417. An external TDD filter 418 is also included in this example. In another example, the TDD filter 418 is included within the module 410.

The HB transmit and receive module 410 further includes a variety of pins, including an HB_TX pin for receiving an HB transmit signal for transmission, an HB_RX1 pin for outputting a first HB receive signal, an HB_RX2 pin for outputting a second HB receive signal, an F1 pin for connecting to one terminal of the external TDD filter 418, and an F2 pin for connecting to another terminal of the external TDD filter 418. The module 410 further includes an HB_ANT1 pin, an HB_ANT2 pin, and an HB_ANT3 pin for connecting to one or more antennas.

FIG. 7C is a schematic diagram of a MB transmit and receive module 420 according to one example.

The RF systems disclosed herein can include one or more implementations of the MB transmit and receive module 420. Although the MB transmit and receive module 420 illustrates one implementation of a MB module, the teachings herein are applicable to RF electronics including MB modules implemented in a wide variety of ways as well as to RF electronics implemented without MB modules.

The MB transmit and receive module 420 includes a first power amplifier 421, a second power amplifier 422, a first low noise amplifier 423, a second low noise amplifier 424, a first duplexer 425, a second duplexer 426, and a multi-throw switch 427. In certain implementations, the first duplexer 425 and the second duplexer 426 provide duplexing to different MB frequency bands. In one example, the first duplexer 425 is operable to duplex Band 3, while the second duplexer 426 is operable to duplex at least one of (or both of) Band 1 and Band 66.

The MB transmit and receive module 420 further includes a variety of pins, including an MB_TX pin for receiving an MB transmit signal for transmission, an MB_RX1 pin for outputting a first MB receive signal, an MB_RX2 pin for outputting a second MB receive signal, and an MB/2G_TX pin for receiving a 2G transmit signal for transmission. The module 420 further includes an MB_ANT1 pin, an MB_ANT2 pin, and an MB_ANT3 pin for connecting to one or more antennas.

FIG. 7D is a schematic diagram of a 2G power amplifier module (PAM) 430 according to one example. FIG. 7E is a schematic diagram of an exemplary uplink carrier aggregation an MIMO module.

The RF systems disclosed herein can include one or more instantiations of the 2G PAM 430. Although the 2G PAM 430 illustrates one implementation of a 2G module, the teachings herein are applicable to RF electronics including 2G modules implemented in a wide variety of ways as well as to RF electronics implemented without 2G modules.

The 2G PAM 430 includes power amplifier circuitry 431, an MB 2G filter 432, and an LB 2G filter 433. The 2G PAM 430 further includes a variety of pins, including an MB/2G_TX pin for receiving a 2G MB transmit signal for transmission and an LB/2G_TX pin for receiving a 2G LB transmit signal for transmission. The module 430 further includes an MB/2G_ANT pin and an LB/2G_ANT pin for connecting to one or more antennas.

### RFFEs and Frequency Bands Used for Wireless Mobile Communications

As already described with regard to the RF system 200 shown in FIG. 5, a RFFE, including four remote placements of UHB PAID modules 221-224 coupled to respective antennas 121-124, supports 4×4 RX MIMO for the UHB band, 4×4 TX MIMO for UHB, and carrier aggregation (CA) with 4G and/or 5G bands. Hence, the UHB PAID modules 221-224 support transmission and reception of one or more UHB frequency bands, including, but not limited to, B42, B4, B3, and/or B48.

However, there can be further frequency bands which are used by different antenna groups for a mobile terminal (e.g., user equipment such as a mobile phone), supporting not only 4G and/or 5G bands, but also 2.4 GHz Wi-Fi and 5 GHz Wi-Fi, as shown in FIG. 7F. As shown in FIG. 7F, frequency bands can be in relatively close proximity, driving isolation and insertion loss challenges. Since a user equipment (e.g., mobile terminal such as a mobile phone) has a limited space for the number of antennas on the near side and the far side of the user equipment, there are challenges in particular regarding the optimal band grouping and antenna flexing to achieve high isolation and low insertion.

As is shown in FIG. 7F, out of the different frequency bands shown on the top in FIG. 7F, certain antenna groups 1, 2 (each comprising bandpass filters and antennas) may be used for enabling operation in the different frequency bands. When steep bandpass filters are used (and the antennas are spaced sufficiently far-away at different positions in the mobile terminal), sufficient isolation can be achieved. However, since space for a large number of antennas (antenna units) is limited in the UE, it can be difficult or impractical to achieve full 4×4 downlink and uplink MIMO simultaneously in all frequency bands.

Certain embodiments described herein allow for 4×4 DL MIMO in the B46 frequency band.

However, FIG. 7F also shows that the existing n79 frequency band BW1 is directly adjacent to the frequency band BW2 used for downlink transmission in the 5 GHz Wi-Fi frequency band. In contrast to this, the 2.4 GHz Wi-Fi is situated far away from the combined bands BW1+BW2=TBW.

Embodiments of the present disclosure leverage the adjacency of the n79 frequency band and the 5 GHz Wi-Fi B46 frequency band, without increasing the number of antenna units, to provide, in addition to the existing two B46 downlink reception paths, two further B46 downlink reception paths by re-using the already existing n79 downlink reception paths. Such concepts will be explained below in detail with reference to FIG. 7K to FIG. 7Q.

### Example of RFFE System in a User Equipment

For providing better understanding how to re-use the n79 downlink reception path also for downlink in the 5 GHz Wi-Fi frequency band, first a typical RFFE system is described below with reference to FIG. 7G to FIG. 7I.

Typically, as was also shown above in FIG. 5, an RFFE system in FIG. 7G comprises an RFFE front end, RFFE, including a receiver system RSY coupled to an antenna system ASY. Typically, as shown in FIG. 7H, the RFFE includes a receiver system RSY comprising a plurality of receiver units RU1, RU2, RU3 . . . . RUm. These receiver units are coupled to a plurality of antenna units AU1, AU2, AU3 . . . . AUn of the antenna system ASY. Typically, as will also be seen from the more detailed block diagram in FIG. 7J, the receiver units are essentially provided for different frequency bands, and also the antenna units comprise different antennas and bandpass filters to be applied for certain frequency bands. However, not necessarily will the number M of receiver units M be equal to the number N of antenna units. That is, due to space restrictions, the antenna units (with their bandpass filters) are designed in such a manner that allows re-use of the antenna units for different receiver units, depending on the location (frequency-wise) of the frequency bands (this is also illustrated in FIG. 7F with the different frequency bands used by the antenna group 1 and the antenna group 2).

A re-use of antenna units for two receiver units RU1, RU2 is also shown in FIG. 7I where the antenna unit AU1 is coupled to two receiver units RU1, RU2. The antenna unit RU1 typically also comprises an antenna ANT1 and a plurality of bandpass filters, BP1, BP2, BP3 . . . . BPn. Typically, in each receiver unit, there will be two receiver sub-units RU1-1, RU 2-1 and RU 1-2, RU 2-2 for providing respective two downlink reception paths Rx1, Rx2 and two up link transmission paths Tx1, Tx2. The sub-units comprise transmit/receive switches Tx/Rx SW1, Tx/Rx SW2 and amplifiers AM1, AM2; AM3, AMm for the respective transmission and reception paths. FIG. 71 is a typical construction of an RFFE system with re-use of existing antenna units to allow 4×4 uplink and/or downlink MIMO for as many frequency bands as possible such as those shown in FIG. 7F discussed above.

### Antenna Units/Receiver Units of Near Side UE/Far Side UE

An example of an RFFE system as in FIG. 71 is shown with more details for the Near side UE and the Far Side UE in FIG. 7J. In particular, FIG. 7J shows (in the dashed box) reception using the B46 2×2 downlink MIMO when using two receiver units RU3, RU4 and two antennas ANT5, ANT6. For the Wi-Fi frequency bands of 2.4 GHZ/5 GHZ, the receiver units RU3, RU4 comprise respective uplink and downlink transmission/reception paths Tx31, Tx32, Rx31, Rx32; Tx41, Tx42, Rx41, Rx42. The 2×2 downlink MIMO reception signals OB46-3, OB46-4 are generated by the reception paths Rx31, Rx41.

In the illustrated example, RU3 and RU4 use a shared common Rx path and split Rx for concurrent DL support of both 5 GHz WiFi Rx and B46 Rx on the 2 antennas ANT5 and ANT6. The RRFE illustrated in FIG. 7J enables separate strong filter attenuation for concurrent coexistence between adjacent bands B46=5 GHz WiFi and n79 (4.4-5 GHZ) but significant IL is suffered to guarantee such performance on each antenna. As explained above, B46 is the same band definition/frequency range as 5 GHz WiFi, and is defined for shared license assisted access (LAA) and includes opportunistic alternating of Tx and concurrent Rx as shown with the common/split Rx paths. However, B46 is limited to 2×2 DL-MIMO because there are only 2 5 GHz WiFi Antennas ANT5, ANT6.

### 4×4 Downlink B46/NR-U Thru n79 Reception Path

FIG. 7K shows an embodiment of a UE RFFE which includes 4 Rx paths Rx11a, Rx21a, Rx50, Rx51 for the n79 band where the 2 Rx paths Rx11, Rx21 are extended (re-used) to include both n79 (Rx11a, Rx21a) and B46 (Rx11b, Rx21b). Thus, the RFFE of FIG. 7K allows for 4×4 DL-MIMO on B46 via the fourth Rx paths Rx11b, Rx21b, Rx31b, Rx41b. If there is Tx activity in the UE in either n79 or B46, the n79 may have to fall back to 2×2 DL-MIMO, while still benefiting from lower IL, while the B46 4×4 DL-MIMO capability doubles the data rate and coverage for the B46 LAA downlink service.

In more detail, FIG. 7K shows a block diagram similar to that in FIG. 7J including the use of four receiver units RU1 to RU4 for realizing full B46 band 4×4 downlink-MIMO according to an embodiment, via the Rx paths Rx11b, Rx21b, Rx31b, Rx41b. As already explained above, FIG. 7K shows the block diagram for extending two of the receiver paths of n79 to include 2 B46 reception paths Rx11b, Rx21b and enable shared use. The receiver units RU1, RU2 of FIG. 7K can be considered modified as compared to those of FIG. 7J

In this manner, the embodiment in FIG. 7K makes use of the four n79 Rx paths Rx50, Rx51, Rx11, Rx21 to allow for shared use of Rx11, Rx21 for both n79 (Rx11a, Rx21a) and B46 (Rx11b, Rx21b) in two of the n79 Rx paths Rx11, Rx21. According to some embodiments, the receiver units RU5, RU5 offer strong coexistence filtering with the 5 GHZ WiFi band and define a passband 4.4-5 GHz, rejecting 5 GHz WiFi frequencies between 5.15-5.85 GHz. For example, the filter f1 of RU5 and the filter f2 of RU6 can each be configured with a passband of 4.4 GHz-5 GHz and reject at least frequencies between 5.15-5.85 GHz or 5.15-5.925 GHz. The 2 receiver units RU1, RU2 are re-designed for shared use of both n79 and B46 with a wider passband 4.4 GHz-5.925 GHz that includes B46. For example, the filter f3 of RU1 and the filter f4 of RU2 can each be configured with a passband of 4.4 GHz-5.925 GHZ. If the UE is transmitting in either n79 or B46, the extended Rx paths Rx11 and Rx21 cannot be concurrently used-meaning that if either B46 Tx or n79 Tx is active, then either band will have to fall back to 2×2 DL-MIMO. For example, if B46 Tx is active, while the filters f1 and f2 of RU5 and RU6 are capable of sufficiently rejecting B46 Tx (5.15 GHz-5.925 GHZ), the filters f3 and f4 of RU1 and RU2 are not, and the RFFE will fall back to 2×2 DL-MIMO on Rx50 and Rx51 for n79 Rx while B46 Tx is active, without using the shared paths Rx11a, Rx21a. Or, for B46 Rx while B46 Tx is active, the RFFE can be configured to fall back to 2×2 DL-MIMO on Rx31b and Rx41b, without using the shared paths Rx11b, Rx21b.

Similarly, if n79 Tx is active, the antenna duplexer filters f5, f6 of RU3 and RU4 respectively may be configured to pass frequencies within between at least 5.15 GHZ-5.925 GHz and reject frequencies below 5.15 GHz, and therefore be capable of sufficiently rejecting n79 Tx (4.4 GHz-5 GHZ). On the other hand, the filters f3, f4 of RU1 and RU2 respectively are not, and thus the RFFE can fall back to 2×2 DL-MIMO on Rx31b, Rx41b for B46 Rx while n79 Tx is active, without using the shared paths Rx11b, Rx21b. Or, for n79 Rx while n79 Tx is active, the RFFE can be configured to fall back to 2×2 DL-MIMO on Rx50 and Rx51 without utilizing the shared paths Rx11a, Rx21a.

But if there is no Tx on in either n79 or B46, as is the case for B46+n79 both receiving, or any time if there is no n79 or B46 Tx active, then full 4×4 DL-MIMO can be enabled for both bands, n79 as well as B46, and RATs concurrently.

As shown in FIG. 7K and in the method in FIG. 7M, the first receiver unit RU1 receives (step 7M1) a first RF signal from the first antenna unit ANT3. The first receiver unit RU1 comprises a first receive path Rx11, and this first receiver path Rx11 is adapted to process (step 7M2) the first RF signal (with a switch, a bandpass filter, an amplifier, and a splitter and further amplifiers (discussed below with reference to FIG. 7L)) to output (step 7M3) a first reception signal OB46-1 in the B46 frequency band on Rx11b and a second reception signal n79 in the n79 frequency band on Rx11a, which is, see FIG. 7F, adjacent to the B46 frequency band. The same construction is used in FIG. 7K and in the method of FIG. 7N for the second receiver unit RU2, which receives (step 7N1) a second RF signal from the antenna unit ANT4 and processes (step 7N2) this signal into two reception signals n79 on Rx21a and OB46-2 on Rx21b which are output (step 7N31) including one output signal as another output signal for the B46 downlink.

As in the existing B46 2×2 downlink MIMO system shown in FIG. 7J, also the B46 4×4 downlink MIMO according to FIG. 7K comprises the third and fourth receiver units RU3, RU4 which each use one respective antenna ANT 5, ANT 6 commonly for the B46, the Wi-Fi band and the 5 GHz Wi-Fi band using respective amplifier and splitter in the respective reception paths Rx31, Rx41. In this regard, as also shown with the method in FIG. 7O, the third receiver unit RU3 includes a first receive path Rx31 to process (step 702) a third RF signal received (step 701) from the antenna ANT5 and to output (step 703) the fifth reception signal OB46-3 on Rx31b in the first frequency band B46 and a sixth reception signal in the 5 GHz Wi-Fi band (a third frequency band) on Rx31a.

Likewise, as also shown in the method of FIG. 7P, the fourth receiver unit RU4 receives (step 7P1) a fourth RF signal from the fourth antenna ANT6 and includes a receiver path Rx41 to process (step 7P2) the fourth RF signal and output (step 7P3) a seventh reception signal OB46-4 in the first frequency band (the B46 frequency band) on Rx41b, and an eighth reception signal in the third frequency band (the 5 GHz Wi-Fi band) on Rx41a.

Hence, in addition to the existing 2×2 downlink MIMO reception signals OB46-3, OB46-4 provided by the receiver units RU3, RU4 (FIG. 7J), the shared use of the n79 reception path Rx11, Rx21 provides two further downlink reception signals for the B46 frequency band without adding further reception paths or adding further antenna units (antennas). This re-the use of the existing n79 reception path (see FIG. 7J) provides two more downlink channels for the B46 frequency band, and hence enables full B46 4×4 downlink MIMO thru the n79 reception path.

According to an embodiment, the first receiver unit RU1 also includes a second reception path Rx12, configured to receive a fifth RF signal from the first antenna unit ANT3 where the second reception path Rx12 of the first receiver unit RU1 is adapted to process the fifth RF signal and output a ninth reception signal in a n77 (fourth) frequency band. Likewise, the second receiver unit RU2 includes a second reception path Rx22 configured to receive a sixth RF signal from the second antenna unit ANT4 (filtered by another bandpass filter), where the second receive path Rx22 of the second receiver unit RU2 is adapted to process the sixth RF signal received from the antenna unit ANT4 and output a tenth reception signal in the fourth frequency band n77.

Furthermore, according to an embodiment, the third receiver unit RU3 includes a second reception path Rx32 to receive a seventh RF signal from the third antenna unit ANT5, where the second reception path Rx32 of the third receiver unit RU3 is adapted to process this seventh RF signal and output an eleventh reception signal in a fifth frequency band (e.g., 2.4 GHz WiFi). Likewise, the fourth receiver unit RU4 has a second reception pass Rx42 for receiving an eighth RF signal from the fourth antenna unit ANT6, where the second Rx path Rx42 of the fourth receiver unit RU4 is adapted to process the received RF signal from the antenna unit ANT6 and output a twelfth reception signal in the fifth frequency band.

As is indicated in the embodiment of FIG. 7J and FIG. 7K, the first frequency band can be the B46 band, the second frequency band can be the n79 band, the third frequency band can be the 5 GHz Wi-Fi band, the fourth frequency band can be the n77 band, and the fifth frequency band can be the 2.4 GHz Wi-Fi band.

Furthermore, according to another embodiment, the first and the third receiver units RU1, RU3 (and their antenna units) are located on the near side of the user equipment and the second and fourth receiver units RU2, RU4 (and their antenna units) are located on a far side of the user equipment, as shown in FIG. 7K, e.g., on opposing faces, sides, edges, or ends of a mobile phone.

### Embodiments of the Receiver Units Enabling Shared Use of Reception Paths

FIG. 7L shows a device, for example a mobile terminal or mobile device, where the antenna system includes a first to fourth antenna unit AU1-AU4 and a radio frequency, RF, front end, RFFE, system including a receiver system with the first to fourth receiver units RU1-RU 4 already generally shown in FIG. 7K. The receiver units RU1-RU4 include transmit and receive paths as already generally described with reference to FIG. 7K. Additionally, they comprise, according to embodiments, the following units/devices in the respective transmission and reception paths Rx11, Rx12; Rx21, Rx22; Rx31, Rx32, Tx31, Tx32; Rx41, Rx42, Tx41, Tx42. The units/devices output the first, third, fifth and seventh reception signals OB46-1, OB46-2, OB46-3, and OB46-4 for the B46 4×4 DL-MIMO reception. The B46 4×4 DL MIMO reception is also illustrated with the method steps in FIG. 7Q.

According to an embodiment, the first Rx path Rx11 of the first receiver unit RU1 comprises a bandpass filter BP11 adapted to filter (step 7Q1) the first RF signal received from the first antenna unit ANT1 with a passband including the first and second frequency bands (n79/B46).

According to another embodiment, the first Rx path Rx21 of the second receiver unit RU2 comprises a bandpass filter BP21 adapted to filter (step 7Q2) the second RF signal received form the second antenna unit ANT2 with a passband including the first and second frequency bands (n79/B46).

According to another embodiment, the first Rx path Rx11 of the first receiver unit RU1 further comprises a first amplifier AM11 configured to amplify (step 7Q3) the filtered first RF signal in a frequency range comprising the first and second frequency band (n79/B46).

According to another embodiment, the first Rx path Rx21 of the second receiver unit RU2 further comprises a first amplifier AM21 configured to amplify (step 7Q4) the filtered second RF signal in a frequency range comprising the first and second frequency band (n79/B46).

According to another embodiment, the first Rx path Rx11 of the first receiver unit RU1 further comprises a first splitter SP11 adapted to split (step 7Q5) the filtered and amplified first RF signal into the first and second reception signals in the B46 frequency band and the adjacent n79 frequency band. The splitter may be embodied as described for various power splitters in U.S. Pat. No. 10,944,377 B2 in the name of the present applicant and which is incorporated in its entirety by reference herein. Typically, such a power splitter has an input and two outputs, as shown in FIG. 7L, and is configured to split the signal of a larger frequency bandwidth TBW (see FIG. 7F) into two output signals each of a different (and adjacent) smaller bandwidth band BW1 and BW2 (see FIG. 7F).

According to another embodiment, the first Rx path of the second receiver unit RU2 further comprises a second splitter SP21 adapted to split (step 7Q6) the filtered and amplified second RF signal into the third and fourth reception signals in the B46 frequency band and the adjacent n79 frequency band. The second splitter SP21 may be embodied as the first splitter SP11 described above.

According to another embodiment, the first Rx path Rx11 of the first receiver unit RU1 further comprises a second amplifier AM11-1 and a third amplifier AM11-2, the second amplifier AM11-1 amplifying the first reception signal in the first frequency range B46, and the third amplifier AM11-2 amplifying the second reception signal in the second frequency range n79 (step 7Q7). The third amplifier AM11-2 outputs the amplified first reception signal OB46-1 which is used as a first one of the four reception signals needed for B46 4×4 DL MIMO.

According to another embodiment, the first Rx path Rx21 of the second receiver unit RU2 further comprises a second amplifier AM21-2 and a third amplifier AM21-1, the second amplifier AM21-2 amplifying the third reception signal in the first frequency range B46, and the third amplifier AM21-1 amplifying the fourth reception signal in the second frequency range n79 (step 7Q8). The third amplifier AM11-2 outputs the amplified second reception signal OB46-2 which is used as a second one of the four reception signals needed for B46 4×4 DL MIMO.

According to another embodiment, the second Rx path Rx21 of the first reception unit RU1 comprises a bandpass filter BP12 configured to filter the fifth RF signal received from the first antenna unit AU1 with a passband including the fourth frequency band n77 and an amplifier AM12 adapted to amplify the filtered fifth RF signal and to output the amplified filtered fifth RF signal as the ninth reception signal in the fourth frequency band n77.

According to another embodiment, the second Rx path Rx22 of the second reception unit RU2 comprises a bandpass filter BP22 configured to filter the sixth RF signal received from the second antenna unit AU2 with a passband including the fourth frequency band n77 and an amplifier AM22 adapted to amplify the filtered sixth RF signal and output the amplified filtered sixth RF signal as the tenth reception signal in the fourth frequency band n77.

According to another embodiment, the first Rx path Rx31 of the third reception unit RU3 comprises an amplifier AM31 configured to amplify the third RF signal received from the third antenna unit AU3, a splitter SP31 adapted to split the amplified third RF signal into the fifth and sixth reception signals, and two amplifiers AM31-1, AM31-2 configured to respectively amplify the fifth and sixth reception signal in the 5 GHz WiFi and B46 frequency bands. The amplifier AM31-2 outputs the amplified fifth reception signal OB46-3 which is used as a third one of the four reception signals needed for B46 4×4 DL MIMO.

According to another embodiment, the first Rx path Rx Rx41 of the fourth reception unit RU4 comprises an amplifier AM41 configured to amplify the fourth RF signal received from the fourth antenna unit AU4, a splitter SP41 adapted to split the amplified fourth RF signal into the seventh and eighth reception signals, and two amplifiers AM41-1, AM41-2 configured to respectively amplify the seventh and eighth reception signal in the 5 GHz WiFi and B46 frequency bands. The amplifier AM41-1 outputs the amplified fifth reception signal OB46-4 which is used as a fourth one of the four reception signals needed for B46 4×4 DL MIMO.

According to still other embodiments, the third receiver unit RU3 and the fourth receiver unit RU4 also comprise a number of transmit/receive switches and transmission paths respectively for the 2.4 GHz Wi-Fi and 5 GHz Wi-Fi frequency bands. In this regard, the third receiver unit RU3 comprises a first transmit/receive switch SW31 which is connected to the receiver amplifier AM31, the transmit amplifier AM31′ and the antenna unit AU3. The transmit amplifier AM31′ is part of the transmit path Tx31 of the third receiver unit RU3. Likewise, there is a second transmit/receive switch SW32 which is connected to the reception amplifier AM32 of the reception path Rx32 and is connected to the transmit amplifier AM32′ of the second transmit path Tx32 for the 2.4 GHz Wi-Fi frequency band. Hence, using the transmit paths Tx32, Tx31 and the transmit amplifier AM31′, AM32′ and the transmit/receive switches SW31, SW32, 2 uplink signals in the 2.4 GHz Wi-Fi and the 5 GHz Wi-Fi frequency bands can be transmitted through the antenna unit AU3.

According to yet another embodiment, a similar configuration is used again for the 2.4 GHz Wi-Fi and 5 GHz Wi-Fi frequency bands in the reception unit RU4 for providing two transmit paths Tx41, Tx42 for 2 transmit signals to be provided to the antenna unit AU4. In this regard, according to still further embodiments, the fourth reception unit RU4 comprises a first transmit/receive switch SW41 which is connected to the receiver amplifier AM41, the transmit amplifier AM41′ and the antenna unit AU4. The transmit amplifier AM41′ is part of the transmit path Tx41 of the fourth receiver unit RU4. Likewise, there is a second transmit/receive switch SW42 which is connected to the reception amplifier AM42 of the reception path Rx42 and is connected to the transmit amplifier AM42′ of the second transmit path Tx42 for the 2.4 GHz Wi-Fi frequency band. Hence, using the transmit paths Tx42, Tx41 and the transmit amplifier AM41′, AM42′ and the transmit/receive switches SW41, SW42, 2 uplink signals in the 2.4 GHz Wi-Fi and the 5 GHz Wi-Fi frequency bands can be transmitted through the antenna unit AU4.

According to yet other embodiments, also the first and second reception units RU1, RU2 comprise transmit/receive switches SW11, SW12 and SW21, SW22, respectively. In FIG. 7L the switches SW11, SW12; SW21, SW22 are shown switched into a reception state providing reception signals from the antenna units AU1, AU2 to the respective reception paths Rx11, Rx21. The switches SW31, SW32 and SW41, SW42 are shown switched into a transmit state in which transmit signals from the transmit paths are provided to the antenna units AU3, AU4 in the respective frequency bands. When also the switches SW31, SW41 are switched to the reception state, full B46 4×4 DL MIMO is conducted along with 2.4 GHz 2×2 uplink MIMO. The shared or re-used n79 reception paths Rx11, Rx21 provide the B46 4×4 downlink MIMO reception with four reception signals without adding further reception paths or antenna units in addition to those shown in FIG. 7J for the different frequency bands.

FIG. 8A is a schematic diagram of one embodiment of a packaged module 800. FIG. 8B is a schematic diagram of a cross-section of the packaged module 800 of FIG. 8A taken along the lines 8B-8B.

The RFFE systems herein can include one or more packaged modules, such as the packaged module 800. Although the packaged module 800 of FIGS. 8A-8B illustrates one example implementation of a module suitable for use in a RFFE system, the teachings herein are applicable to modules implemented in other ways.

The packaged module 800 includes radio frequency components 801, a semiconductor die 802, surface mount devices 803, wirebonds 808, a package substrate 820, and encapsulation structure 840. The package substrate 820 includes pads 806 formed from conductors disposed therein. Additionally, the semiconductor die 802 includes pins or pads 804, and the wirebonds 808 have been used to connect the pads 804 of the die 802 to the pads 806 of the package substrate 820.

As shown in FIG. 8B, the packaged module 800 is shown to include a plurality of contact pads 832 disposed on the side of the packaged module 800 opposite the side used to mount the semiconductor die 802. Configuring the packaged module 800 in this manner can aid in connecting the packaged module 800 to a circuit board, such as a phone board of a wireless device. The example contact pads 832 can be configured to provide radio frequency signals, bias signals, and/or power (for example, a power supply voltage and ground) to the semiconductor die 802. As shown in FIG. 8B, the electrical connections between the contact pads 832 and the semiconductor die 802 can be facilitated by connections 833 through the package substrate 820. The connections 833 can represent electrical paths formed through the package substrate 820, such as connections associated with vias and conductors of a multilayer laminated package substrate.

In some embodiments, the packaged module 800 can also include one or more packaging structures to, for example, provide protection and/or facilitate handling. Such a packaging structure can include overmold or encapsulation structure 840 formed over the packaging substrate 820 and the components and die(s) disposed thereon.

It will be understood that although the packaged module 800 is described in the context of electrical connections based on wirebonds, one or more features of the present disclosure can also be implemented in other packaging configurations, including, for example, flip-chip configurations.

FIG. 9 is a schematic diagram of one embodiment of a mobile device 900. The mobile device 900 includes a baseband system 901, a transceiver 902, a front-end system 903, antennas 904, a power management system 905, a memory 906, a user interface 907, and a battery 908.

The mobile device 900 can be used communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 902 generates RF signals for transmission and processes incoming RF signals received from the antennas 904.

The front-end system 903 aids in conditioning signals transmitted to and/or received from the antennas 904. In the illustrated embodiment, the front-end system 903 includes power amplifiers (PAS) 911, low noise amplifiers (LNAs) 912, filters 913, switches 914, and duplexers 915. However, other implementations are possible.

For example, the front-end system 903 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 900 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 904 can include antennas used for a wide variety of types of communications. For example, the antennas 904 can include antennas for transmitting and/or receiving signals associated with a wide variety of frequencies and communications standards.

In certain implementations, the antennas 904 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 900 can operate with beamforming in certain implementations. For example, the front-end system 903 can include phase shifters having variable phase controlled by the transceiver 902. Additionally, the phase shifters are controlled to provide beam formation and directivity for transmission and/or reception of signals using the antennas 904. For example, in the context of signal transmission, the phases of the transmit signals provided to the antennas 904 are controlled such that radiated signals from the antennas 904 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 904 from a particular direction. In certain implementations, the antennas 904 include one or more arrays of antenna elements to enhance beamforming.

The baseband system 901 is coupled to the user interface 907 to facilitate processing of various user input and output (I/O), such as voice and data. The baseband system 901 provides the transceiver 902 with digital representations of transmit signals, which the transceiver 902 processes to generate RF signals for transmission. The baseband system 901 also processes digital representations of received signals provided by the transceiver 902. As shown in FIG. 9, the baseband system 901 is coupled to the memory 906 of facilitate operation of the mobile device 900.

The memory 906 can be used for a wide variety of purposes, such as storing data and/or instructions to facilitate the operation of the mobile device 900 and/or to provide storage of user information.

The power management system 905 provides a number of power management functions of the mobile device 900. In certain implementations, the power management system 905 includes a PA supply control circuit that controls the supply voltages of the power amplifiers 911. For example, the power management system 905 can be configured to change the supply voltage(s) provided to one or more of the power amplifiers 911 to improve efficiency, such as power added efficiency (PAE).

As shown in FIG. 9, the power management system 905 receives a battery voltage from the battery 908. The battery 908 can be any suitable battery for use in the mobile device 900, including, for example, a lithium-ion battery.

The front-end system 903 of FIG. 9 can be implemented in accordance with one or more features of the present disclosure. Although the mobile device 900 illustrates one example of a RF communication device that can include a RFFE system implemented in accordance with the present disclosure, the teachings herein are applicable to a wide variety of RF electronics.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece or smart eyeglasses or virtual reality equipment, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, IoT radios, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly coupled, or coupled by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio frequency front end system comprising:
a first receiver system including a first receive path connected to a first antenna and configured to output a first receive signal in a first band, a second receive path connected to a second antenna and configured to split a first filtered receive signal to output a second receive signal in the first band and to output a third receive signal in a second band, the second band adjacent to the first band, and a third receive path connected to a third antenna and configured to output a fourth receive signal in the second band; and
a second receiver system including a fourth receive path connected to a fourth antenna and configured to output a fifth receive signal in the first band, a fifth receive path connected to a fifth antenna and configured to split a second filtered receive signal to output a sixth receive signal in the first band and to output a seventh receive signal in the second band, and a sixth receive path connected to a sixth antenna and configured to output an eighth receive signal in the second band.

2. The radio frequency front end system of claim 1 wherein the radio frequency front end system is adapted to output the first, second, fifth, and sixth receive signals simultaneously for 4×4 DL-MIMO operation in the first band.

3. The radio frequency front end system of claim 2 wherein the radio frequency front end system is adapted to output the third, fourth, seventh, and eighth receive signals simultaneously for 4×4 DL-MIMO operation in the second band.

4. The radio frequency front end system of claim 1 wherein the first band is 4G LTE B46 and the second band is 5G NR n79.

5. The radio frequency front end system of claim 1 the third receive path is configured to split a third filtered receive signal to output the fourth receive signal in the second band and to output a ninth receive signal in a third band, and the sixth receive path is configured to split a fourth filtered receive signal to output the eighth receive signal in the second band and to output a tenth receive signal in the third band.

6. The radio frequency front end system of claim 5 wherein the first band is 4G LTE B46, the second band is 5G NR n79, and the third band is 5 GHz WiFi.

7. The radio frequency front end system of claim 1 wherein the first receiver system is positioned in a first location in a mobile device, and the second receiver system is positioned in a second location in the mobile device spaced from the first location.

8. The radio frequency front end system of claim 7 wherein the first location is within a near side of the mobile device, and the second location is within a far side of the mobile device.

9. The radio frequency front end system of claim 1 wherein the second receive path includes a first bandpass filter adapted to filter the first filtered receive signal with a passband having a frequency range including the first band and the second band, and the fifth receive path includes a second bandpass filter adapted to filter the second filtered receive signal with a passband having a frequency range including the first band and the second bands.

10. The radio frequency front end system of claim 9 wherein the second receive path includes a first power splitter configured to split the first filtered receive signal into the second receive signal and third receive signal, and the fifth receive path includes a second power splitter configured to split the second filtered receive signal into the sixth receive signal and the seventh receive signal.

11. The radio frequency front end system of claim 10 wherein the second receive path further includes a first amplifier amplifying the second receive signal in a first frequency range including the first band, and a second amplifier amplifying the third receive signal in a second frequency range including the second band, and the fifth receive path further includes a third amplifier amplifying the sixth receive signal in the first frequency range, and a fourth amplifier amplifying the seventh receive signal in the second frequency range.

12. A mobile device comprising:
first, second, third, fourth, fifth, and sixth antennas; and
a radio frequency front end system including a first receive path connected to a first antenna and configured to output a first receive signal in a first band, a second receive path connected to a second antenna and configured to split a first filtered receive signal to output a second receive signal in the first band and to output a third receive signal in a second band, the second band adjacent to the first band, a third receive path connected to a third antenna and configured to output a fourth receive signal in the second band, a fourth receive path connected to a fourth antenna and configured to output a fifth receive signal in the first band, a fifth receive path connected to a fifth antenna and configured to split a second filtered receive signal to output a sixth receive signal in the first band and to output a seventh receive signal in the second band, and a sixth receive path connected to a sixth antenna and configured to output an eighth receive signal in the second band.

13. The mobile device of claim 12 wherein the radio frequency front end system is adapted to output the first, second, fifth, and sixth receive signals simultaneously for 4×4 DL-MIMO operation in the first band.

14. The mobile device of claim 13 wherein the radio frequency front end system is adapted to output the third, fourth, seventh, and eighth receive signals simultaneously for 4×4 DL-MIMO operation in the second band.

15. The mobile device of claim 12 wherein the first band is 4G LTE B46 and the second band is 5G NR n79.

16. The mobile device of claim 12 the third receive path is configured to split a third filtered receive signal to output the fourth receive signal in the second band and to output a ninth receive signal in a third band, and the sixth receive path is configured to split a fourth filtered receive signal to output the eighth receive signal in the second band and to output a tenth receive signal in the third band.

17. The mobile device of claim 16 wherein the first band is 4G LTE B46, the second band is 5G NR n79, and the third band is 5 GHz WiFi.

18. The mobile device of claim 12 wherein the first, second, and third receive paths are positioned in a first location in a mobile device, and the fourth, fifth, and sixth receive paths are positioned in a second location in the mobile device spaced from the first location.

19. The mobile device of claim 18 wherein the first location is within a near side of the mobile device, and the second location is within a far side of the mobile device.

20. The mobile device of claim 12 wherein the second receive path includes a first bandpass filter adapted to filter the first filtered receive signal with a passband having a frequency range including the first band and the second band, and the fifth receive path includes a second bandpass filter adapted to filter the second filtered receive signal with a passband having a frequency range including the first band and the second bands.
